(19) United States
(12) Patent Application Publication
(10) Pub. No.: US 2025/0184040 A1
(43) Pub. Date: Jun. 5, 2025

(54) INFORMATION TRANSMISSION METHOD AND DEVICE, AND STORAGE MEDIUM

(71) Applicant: ZTE CORPORATION, Shenzhen (CN)

(72) Inventors: Jie CHEN, Shenzhen (CN); Youxiong LU, Shenzhen (CN); Weimin XING, Shenzhen (CN); Haigang HE, Shenzhen (CN)

(21) Appl. No.: 18/725,515

(22) PCT Filed: Dec. 13, 2022
(86) PCT No.: PCT/CN2022/138762

§ 371 Date: Jun. 28, 2024

(30) Foreign Application Priority Data
Dec. 29, 2021 (CN) 202111644295.2

(51) Int. Cl. H04L 1/06; H04L 1/1867; H04W 72/25

(52) U.S. Cl. CPC H04L 1/0687; H04L 1/1896; H04W 72/25

(57) ABSTRACT

Provided are an information transmission method and device, and a storage medium. The information transmission method applied to a first communication node includes: sending feedback indication information to a second communication node according to configuration information or pre-configuration information, and receiving feedback information sent by the second communication node according to the configuration information or pre-configuration information and the feedback indication information.

### CROSS-REFERENCES TO RELATED APPLICATIONS

This is a National Stage Application, filed under 35 U.S.C. 371, of International Patent Application No. PCT/CN2022/138762, filed on Dec. 13, 2022, which is based on and claims priority to Chinese Patent Application No. 202111644295.2 filed with the China National Intellectual Property Administration (CNIPA) on Dec. 29, 2021, the disclosures of which are incorporated herein by reference in their entireties.

### FIELD

The present application relates to the field of communications, for example, to an information transmission method and device, and a storage medium.

### BACKGROUND

In end-to-end sidelink (SL) communications, if SL hybrid automatic repeat request (HARQ) feedback is enabled, a physical SL feedback channel (PSFCH) resource exists at a fixed time-domain location in an SL communication resource pool according to a configured signaling or a pre-configured signaling. One or more resource blocks (RBs) on a PSFCH symbol can be uniquely determined for each physical SL shared channel (PSSCH) resource in the SL resource pool as a feedback resource according to a pre-defined rule, and only one feedback opportunity is provided. Such a working mode works well in a licensed frequency band or an Intelligent Transportation Systems (ITS) frequency band; however, in some cases, for example, in an unlicensed frequency band, a receiving end user equipment (UE) often fails to send feedback information normally on the PSFCH resource corresponding to a PSSCH since the receiving end UE does not have a Listen Before Talk (LBT) success SL channel, or the receiving end UE fails to send feedback information normally at a current opportunity due to priority, power or equipment capacity limitations.

For a non-acknowledgment (NACK)-only scenario, a transmitting end UE cannot determine whether to determine as an acknowledgment (ACK) since the receiving end UE receives the data correctly but does not feed back HARQ information or to determine as a NACK since the receiving end UE fails to receive the data but does not feed back HARQ information due to a lack of an LBT success channel. For an ACK/NACK feedback scenario, the transmitting end UE considers as a NACK since the HARQ feedback information is not sent, thereby resulting in a low SL transmission efficiency. It is expected to provide multiple feedback opportunities for each PSSCH transmission on the SL so that the HARQ feedback information can be transmitted to the transmitting end UE with a higher probability, thereby reducing the impact of an LBT mechanism in the unlicensed frequency band on SL HARQ feedback or reducing the impact of other cases, where the feedback information cannot be normally sent, on SL HARQ feedback and improving SL communication efficiency. Therefore, how to provide more time-domain feedback opportunities for SL PSSCH transmission and how the receiving end UE further performs feedback are problems demanding prompt solutions.

### SUMMARY

Embodiments of the present application provide an information transmission method. The information transmission method is applied to a first communication node and includes the following operations.

Feedback indication information is sent to a second communication node according to configuration information or pre-configuration information.

Feedback information sent by the second communication node according to the configuration information or pre-configuration information and the feedback indication information is received.

Embodiments of the present application provide an information transmission method. The information transmission method is applied to a second communication node and includes the following operations.

Feedback indication information sent by a first communication node according to configuration information or pre-configuration information is received.

Feedback information is sent to the first communication node according to the configuration information or pre-configuration information and the feedback indication information.

Embodiments of the present application provide an information transmission device. The information transmission device includes a communication module, a memory and one or more processors. The communication module is configured to perform communication interaction between multiple communication nodes. The memory is configured to store one or more programs. The one or more programs, when executed by the one or more processors, cause the one or more processors to implement the method in any of the above embodiments.

The embodiments of the present application provide a storage medium. The storage medium is configured to store a computer program which, when executed by a processor, causes the processor to implement the method in any of the above embodiments.

### BRIEF DESCRIPTION OF DRAWINGS

FIG. 1 is a schematic diagram of PSFCH resource time-domain mapping according to an embodiment of the present application;

FIG. 2 is a schematic diagram of frequency-domain mapping according to an embodiment of the present application;

FIG. 3 is a flowchart of an information transmission method according to an embodiment of the present application;

FIG. 4 is another flowchart of an information transmission method according to an embodiment of the present application;

FIG. 5 is a schematic diagram of feedback of feedback information according to an embodiment of the present application;

FIG. 6 is a schematic diagram of an allocation of HARQ process groups according to an embodiment of the present application;

FIG. 7 is a schematic diagram of an allocation of HARQ processes and feedback resources according to an embodiment of the present application;

FIG. 8 is another schematic diagram of an allocation of HARQ processes and feedback resources according to an embodiment of the present application;

FIG. 9 is another schematic diagram of an allocation of HARQ processes and feedback resources according to an embodiment of the present application;

FIG. 10 is another schematic diagram of an allocation of HARQ processes and feedback resources according to an embodiment of the present application;

FIG. 11 is another schematic diagram of an allocation of HARQ processes and feedback resources according to an embodiment of the present application;

FIG. 12 is a block diagram of an information transmission apparatus according to an embodiment of the present application;

FIG. 13 is another block diagram of an information transmission apparatus according to an embodiment of the present application; and

FIG. 14 is a structure diagram of an information transmission device according to an embodiment of the present application.

### DETAILED DESCRIPTION

Embodiments of the present application will be described below in conjunction with drawings. The present application will be described in conjunction with the drawings of embodiments, and examples described hereinafter are intended to explain the present application and not to limit the scope of the present application.

Each SL UE can obtain configuration information of a resource pool for SL communication based on configuration information or pre-configuration information, and UE-to-UE SL communication supports unicast, multicast and broadcast based on a configuration of the resource pool for the SL communication. For unicast and multicast, the 3GPP protocol supports enabled HARQ feedback. For unicast, ACK/NACK feedback is supported, and for multicast, NACK-only feedback and ACK/NACK feedback of a group member to data are supported.

Regardless of which feedback method, a PSFCH feedback resource corresponding to each PSSCH transmission is uniquely determined according to the configuration or pre-configuration information. Taking unicast as an example, assuming that SL HARQ feedback is enabled, a receiving UE performs feedback on the uniquely determined PSFCH resource for each PSSCH transmission of the transmitting end, and the method of determining the PSFCH feedback resource is as follows:

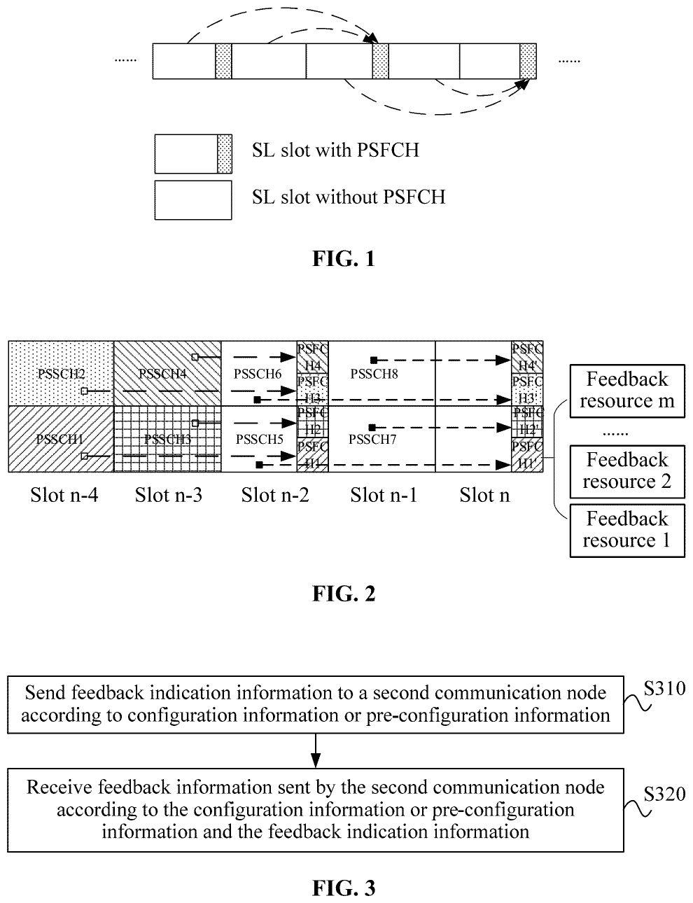

The UE first determines, according to a configured or preconfigured PSFCH period, a slot in which PSFCH resources are located in an SL communication resource pool, where the feedback slot is a PSFCH slot that is after and closest to a PSSCH and satisfies the minimum feedback delay. For example, it is assumed that the configured PSFCH period is 2, and the minimum feedback delay is one slot. FIG. 1 is a schematic diagram of PSFCH resource time-domain mapping according to an embodiment of the present application. As shown in FIG. 1, every two PSSCH time-domain resources are fixedly mapped to one PSFCH time-domain resource.

For example, a system determines the unicast attribute or multicast attribute of transmitting data according to time-frequency locations of PSSCH transmission, and the receiving end UE determines a unique PSFCH feedback resource set within the PSFCH slot through mapping. One PSFCH feedback resource set includes multiple PSFCH feedback resources, and the feedback resource of each receiving UE is determined based on a source ID of a transmitting end UE and a member ID of the receiving UE. It can be seen that, for each transmit-receive link required feedback, the transmitting end UE and the receiving UE together determine one feedback resource in a unique PSFCH resource set according to the resource pool configuration. FIG. 2 is a schematic diagram of frequency-domain mapping according to an embodiment of the present application. The mapping relationship between PSSCHs and PSFCH feedback resources is shown in FIG. 2.

As can be seen from FIGS. 1 and 2, each time-domain PSSCH transmission corresponds to only one fixed feedback opportunity in the time domain. In an unlicensed band, if the receiving UE does not have an LBT success in the feedback opportunity, the SL transmission efficiency is greatly affected, so when SL HARQ feedback is performed in the unlicensed band, how to provide more feedback opportunities for each time-domain PSSCH transmission becomes a problem demanding prompt solutions.

In view of the above, embodiments of the present application provide a method that may provide multiple feedback opportunities for PSSCH transmission, that is, a transmitting end indicates information about HARQ feedback to a receiving end UE, and when the feedback information corresponding to a current PSSCH cannot be normally sent, the receiving end re-feeds back the HARQ information of to-be-fed-back data on a next available feedback resource corresponding to PSSCH according to indication information in one of the received sidelink control information (SCI), or an SCI and a higher-layer signaling, in conjunction with the higher-layer configuration information or pre-configuration information.

In an embodiment, FIG. 3 is a flowchart of an information transmission method according to an embodiment of the present application. The embodiment may be executed by an information transmission device. The information transmission device may be a first communication node. For example, the first communication node may be a transmitting end UE. As shown in FIG. 3, the embodiment includes S310 and S320.

In S310, feedback indication information is sent to a second communication node according to configuration information or pre-configuration information.

The pre-configuration information refers to the information pre-configured for the first communication node and the second communication node according to a communication protocol before the first communication node and the second communication node leave the factory, and the configuration information refers to the information configured for the first communication node and the second communication node according to negotiation with a core network or a base station. Both the first communication node and the second communication node carry the configuration information or the pre-configured information.

In the embodiment, the feedback indication information is used for indicating whether to feed back feedback information of to-be-fed-back data before current data.

In S320, feedback information sent by the second communication node according to the configuration information or pre-configuration information and the feedback indication information is received.

In the embodiment, after the first communication node sends the feedback indication information to the second communication node, the second communication node generates feedback information corresponding to the current data or feedback information corresponding to the current data and the to-be-fed-back data according to the configuration information or pre-configuration information and the feedback indication information and sends the feedback information to the first communication node so that the feedback information of the to-be-fed-back data may re-feed back with HARQ information on a next available feedback resource.

In an embodiment, the feedback indication information includes at least one of the following: first feedback indication information indicated in physical layer control information or second feedback indication information indicated in a higher-layer signaling. In the embodiment, the physical layer control information refers to an SCI, and the higher-layer signaling may be a media access control-control element (MAC-CE) signaling or may be a radio resource control (RRC) signaling, which is not limited herein.

In an embodiment, the operation of receiving the feedback information sent by the second communication node according to the configuration information or pre-configuration information and the feedback indication information includes one of the following operations of:
receiving feedback information sent by the second communication node on a corresponding PSFCH feedback resource according to the configuration information or pre-configuration information and the first feedback indication information;
receiving feedback information sent by the second communication node by using a sidelink data channel and/or a sidelink control channel in a feedback delay according to the configuration information or pre-configuration information, the first feedback indication information and the second feedback indication information;
receiving feedback information sent by the second communication node on a corresponding PSFCH feedback resource according to the configuration information or pre-configuration information, the first feedback indication information and the second feedback indication information; or
receiving feedback information sent by the second communication node by using a sidelink data channel and/or a sidelink control channel in a feedback delay according to the configuration information or pre-configuration information and the first feedback indication information.

In an embodiment, the first feedback indication information is indication information in an SCI. The first feedback indication information includes at least one of the following: 1-bit indication information, bitmap indication information, to-be-fed-back HARQ process group index indication information, sidelink counter assignment index (SL-SAI) indication information or new feedback indication (NFI) indication information.

In an embodiment, the second feedback indication information is indication information carried in a higher layer on a sidelink. The second feedback indication information includes one of the following: to-be-fed-back HARQ process indication information, to-be-fed-back HARQ process group index indication information, to-be-fed-back slot indication information or to-be-fed-back slot group index indication information.

In an embodiment, the configuration information or pre-configuration information includes one of the following: information for configuring K groups of HARQ processes, where K is a positive integer greater than or equal to 1; or a feedback delay.

In an embodiment, the first feedback indication information includes 1-bit indication information. The 1-bit indication information is used for indicating that feedback information on the PSFCH feedback resource includes one of the following: feedback information of an HARQ process corresponding to current data, or feedback information of all to-be-fed-back HARQ processes in an HARQ process group in which an HARQ process corresponding to current data is located.

In an example, it is assumed that SL communication maintains a total of N processes, and the N processes are grouped into K groups. In the case where HARQ feedback is enabled, the SCI contains one piece of 1-bit indication information denoted by OneOrMoreFlag, and the 1-bit indication information indicates that feedback information on the PSFCH feedback resource corresponding to a current PSSCH includes one of the following: only feeding back HARQ information of an HARQ process corresponding to current data or feeding back HARQ information of all data in an HARQ process group in which an HARQ process corresponding to current data is located.

In the case where the transmitting end UE requires the receiving end UE to only feed back the HARQ information of the HARQ process corresponding to the current data, the OneOrMoreFlag in the SCI is set to 0; in the case where the transmitting end UE requires the receiving end UE to feed back the HARQ information of all data in the HARQ process group in which the HARQ process corresponding to the current data is located, the OneOrMoreFlag in the SCI is set to 1.

In the embodiment, SL communication maintains a total of N processes, the N processes are grouped into K groups, and the grouping information is configured per resource pool, is pre-configured or is configured per UE through a PC5 RRC signaling.

In an embodiment, the first feedback indication information includes to-be-fed-back HARQ process group index indication information. The to-be-fed-back HARQ process group index indication information is represented by a code point, and the number of code points is related to the number of HARQ process groups.

The to-be-fed-back HARQ process group index indication information is used for indicating that the feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

One code point is used for indicating feeding back the feedback information of the HARQ process corresponding to the current data, and other code points are in a one-to-one correspondence with group indexes of the HARQ process groups.

In an example, it is assumed that SL communication maintains a total of N processes, and the N processes are grouped into K groups. In the case where HARQ feedback is enabled, the SCI contains indication information, and the indication information indicates that feedback information on the PSFCH feedback resource corresponding to a current PSSCH includes one of the following: only feeding back HARQ information of an HARQ process corresponding to current data; if an HARQ process corresponding to current data is included in an i-th HARQ process group, feeding back all pieces of HARQ information in the i-th HARQ process group indicated; or if an HARQ process corresponding to current data is not included in an i-th HARQ process group, feeding back HARQ information of all HARQ processes in the i-th HARQ process group indicated and HARQ information of the HARQ process corresponding to the current data.

The indication information is log₂(K+1) rounded up. one code point is used for indicating feeding back the HARQ information of the HARQ process corresponding to the current data, and other K code points are in a one-to-one correspondence with group indexes of K HARQ process groups.

A certain code point of the indication information in the SCI is used for indicating that the transmitting end UE requires the receiving end UE to only feed back the HARQ information of the current data. In the case where the transmitting end UE requires the receiving end UE to feed back the HARQ information of the current data and HARQ information of all other to-be-fed-back data in an i-th HARQ process group, the transmitting end UE indicates a code point corresponding to the index of the i-th HARQ process group in the SCI.

Alternatively, 1 bit in the SCI is used for indicating whether to only feed back the HARQ information of the current data, which is denoted by OneOrMoreFlag. OneOrMoreFlag=0 represents that only the HARQ information of the current data is fed back. OneOrMoreFlag=1 represents that in addition to the HARQ information of the current data, the HARQ information of other to-be-fed-back data is required to be fed back, where the other to-be-fed-back data is indicated according to process group indexes, a certain piece of determined feedback information is indicated by using one code point in log₂(K) rounded up, and K code points are in a one-to-one correspondence with group indexes of K process groups.

In an example, if no K groups of processes are configured or pre-configured, K is equal to 1 by default, and then the HARQ process group index information is not required to be indicated.

In the embodiment, SL communication maintains a total of N processes, and the N processes are grouped into K groups that are configured per resource pool, are pre-configured or are configured per UE through a PC5 RRC signaling.

In an embodiment, the grouping manner of the HARQ process groups includes one of the following: directly pre-configuring or configuring K groups of HARQ processes; or the HARQ information of the total number of HARQ processes and the number of processes in an HARQ process group, and determining K groups of HARQ processes according to the number of processes in the HARQ process group and the total number of HARQ processes.

In an embodiment, the first feedback indication information includes one of the following: 1-bit indication information, SL-SAI indication information or NFI indication information.

The 1-bit indication information is used for indicating that the feedback information on the PSFCH feedback resource includes one of the following: feedback information of an HARQ process corresponding to current data, or feedback information of an HARQ processes corresponding to current data and all to-be-fed-back data; where the to-be-fed-back data is data for which feedback is required and is before the current data and determined according to at least one of an SL-SAI or an NFI.

The SL-SAI indication information is used for indicating a count index of an SCI in a physical sidelink control channel (PSCCH).

The NFI indication information is used for indicating whether current SL-SAI indication information is a new count index.

In an example, HARQ information of data for which feedback is failure is generated and fed back according to the three pieces of indication information: an SL-SAI, OneOrMoreFlag and an NFI indicated in the SCI.

At least one bit field in the SCI is used for indicating one of the following:
1-bit indication information for indicating whether to only feed back the HARQ information of the HARQ process corresponding to the current data, which is denoted by OneOrMoreFlag;
SL-SAI indication information for indicating the total number of PSCCHs/PSSCHs until the data indicated by the current SCI; or
NFI indication information of 1 bit is used for indicating whether an SL-SAI is a new count or an old count, and NFI flipping indicates that the SL-SAI is the new count.

OneOrMoreFlag=1 indicates that the HARQ information of all the to-be-fed-back data is fed back, and the data are the PSCCHs/PSSCHs counted by the SAL. OneOrMoreFlag=0 indicates that only the HARQ information of the current data is fed back.

Whether the NFI is flipped represents whether the current SAI is a new count index or an old count index. Once the NFI is flipped, the count of the current SAI restarts, and the saved HARQs corresponding to the PSSCHs which are counted by the SAI before the flipping are cleared and are no longer fed back.

In the case where the transmitting end UE requires the receiving end UE to only feed back the HARQ information of the HARQ process corresponding to the current data, the OneOrMoreFlag in the SCI is set to 0; in the case where the transmitting end UE requires the receiving end UE to feed back the HARQ information of the current data and HARQ information of other to-be-fed-back data, the transmitting end UE indicates in the SCI that the OneOrMoreFlag is set to 1 and indicates the counter SL-SAI of the current SCI and the new/old count indication NFI.

In an embodiment, the configuration information or pre-configuration information includes a feedback delay, the first feedback indication information includes 1-bit indication information, and the second feedback indication information includes to-be-fed-back HARQ process indication information or to-be-fed-back HARQ process group index indication information.

The 1-bit indication information is used for indicating an enabling situation of sending feedback information in the feedback delay.

The to-be-fed-back HARQ process indication information is used for indicating process numbers of all processes, for which HARQ is to be fed back, before current data.

The to-be-fed-back HARQ process group index indication information is used for indicating HARQ processes in all process groups, for which HARQ is to be fed back, before current data.

The starting position of the feedback delay includes one of the following: a slot in which a PSFCH feedback resource corresponding to current data is located; a first slot after a slot in which a PSFCH feedback resource corresponding to current data is located; a slot in which a data resource or a control resource is located; or a first slot after a slot in which a data resource or a control resource is located.

In an example, one feedback delay T is configured by a higher layer or pre-configured. The feedback delay starts from a slot in which the first PSFCH feedback resource corresponding to a PSSCH is located, the transmitting end UE instructs the receiving end UE to send the SCI and/or data for HARQ feedback in the feedback delay window T after the PSFCH resource.

The flag in the SCI of the transmitting end UE is for indicating whether to enable feedback in the delay, and the flag is denoted by OneOrMoreFlag.

OneOrMoreFlag=0 represents that feedback is not enabled, which indicates that the receiving end UE only feeds back the HARQ information of the current data on the PSFCH feedback resource corresponding to the data.

OneOrMoreFlag=1 represents that feedback is enabled, which indicates that the receiving end UE feeds back the HARQ information of all to-be-fed-back data by using the SCI and/or data in the delay T after the slot in which the PSFCH feedback resource corresponding to the data is located. All the to-be-fed-back data may refer to data in all processes or specified to-be-fed-back data indicated by the SCI (for example, the data indicating the process number(s) of process(es) of which the transmitting end UE needs the feedback or the data counted by the SL-SAI).

The transmitting end UE indicates OneOrMoreFlag=1 and then receives the HARQ information fed back by the receiving end UE in the delay T after the PSFCH slot corresponding to the PSSCH. If the transmitting end UE does not receive the feedback information of these processes, for which the feedback is to be performed, in the feedback delay T, the transmitting end UE determines the HARQ information of these to-be-fed-back data as a NACK.

The feedback delay T in the method is configured per resource pool, is pre-configured or is configured per UE through a PC5 RRC signaling.

In an example, one feedback delay T is configured by a higher layer or pre-configured, and the feedback delay starts from the slot in which the first PSFCH feedback resource corresponding to a PSSCH is located. The transmitting end UE instructs the receiving end UE to send the SCI and/or data for HARQ feedback in the feedback delay window T after the PSFCH resource.

The flag in the SCI of the transmitting end UE is for indicating whether to enable feedback in the delay, and the flag is denoted by OneOrMoreFlag.

OneOrMoreFlag=0 represents that feedback is not enabled, which indicates that the receiving end UE only feeds back the HARQ information of the current data on the PSFCH feedback resource corresponding to the data.

OneOrMoreFlag=1 represents that feedback is enabled, which indicates that the receiving end UE feeds back the HARQ information of all to-be-fed-back data by using the SCI and/or data in the delay T after the slot in which the PSFCH feedback resource corresponding to the data is located. All the to-be-fed-back data may refer to data which is for feedback that are configured via RRC or pre-configured (for example, the data indicating the process number(s) of process(es) of which feedback is required by the transmitting end UE).

The transmitting end UE indicates OneOrMoreFlag=1 and then receives the HARQ information fed back by the receiving end UE in the delay T after the PSFCH slot corresponding to the PSSCH. If the transmitting end UE does not receive the feedback information of these to-be-fed-back processes in the feedback delay T, the transmitting end UE determines the HARQ information of these to-be-fed-back data as NACK.

In an embodiment, the configuration information or pre-configuration information includes a feedback delay, the first feedback indication information includes 1-bit indication information, and the second feedback indication information includes to-be-fed-back slot indication information or to-be-fed-back slot group index indication information.

The 1-bit indication information is used for indicating an enabling situation of sending feedback information in the feedback delay.

The to-be-fed-back slot indication information is used for indicating indexes of all slots, for which feedback is to be perform, before a slot corresponding to the current data.

The to-be-fed-back slot group index indication information is used for indicating HARQ processes in slots, for which feedback is to be perform, in all slot groups, for which feedback is to be perform, before a slot corresponding to the current data.

The starting position of the feedback delay includes one of the following: a slot in which a PSFCH feedback resource corresponding to the current data is located, a first slot after a slot in which a PSFCH feedback resource corresponding to the current data is located, a slot in which a data resource or a control resource is located, or a first slot after a slot in which a data resource or a control resource is located.

In an example, one feedback delay T is configured by a higher layer or pre-configured, and the feedback delay starts from the slot in which the first PSFCH feedback resource corresponding to a PSSCH is located. The transmitting end UE instructs the receiving end UE to send the SCI and/or data for HARQ feedback in the feedback delay window T after the PSFCH resource.

The flag in the SCI of the transmitting end UE is for indicating whether to enable feedback in the delay, and the flag is denoted by OneOrMoreFlag.

OneOrMoreFlag=0 indicates that feedback is not enabled, which indicates that the receiving end UE only feeds back the HARQ information of the current data on the PSFCH feedback resource corresponding to the data.

OneOrMoreFlag=1 indicates that feedback is enabled, which indicates that the receiving end UE feeds back the HARQ information of all to-be-fed-back data by using the SCI and/or data in the delay T after the slot in which the PSFCH feedback resource corresponding to the data is located. All the to-be-fed-back data may refer to data in all slots or specified to-be-fed-back data indicated by the SCI (for example, the indicated slot(s) of which feedback is required by the transmitting end UE or data counted by the SL-SAI).

The transmitting end UE indicates OneOrMoreFlag=1 and then receives the HARQ information fed back by the receiving end UE in the delay T after the PSFCH slot corresponding to the PSSCH. If the transmitting end UE does not receive the feedback information of these to-be-fed-back slots in the feedback delay T, the transmitting end UE determines the HARQ information of these to-be-fed-back data as NACK.

The feedback delay T in the method is configured per resource pool, is pre-configured or is configured per UE through a PC5 RRC signaling.

In an example, one feedback delay T is configured by a higher layer or pre-configured, and the feedback delay starts from the slot in which the first PSFCH feedback resource corresponding to a PSSCH is located. The transmitting end UE instructs the receiving end UE to send the SCI and/or data for HARQ feedback in the feedback delay window T after the PSFCH resource.

The flag in the SCI of the transmitting end UE is for indicating whether to enable feedback in the delay, and the flag is denoted by OneOrMoreFlag.

OneOrMoreFlag=0 represents that feedback is not enabled, which indicates that the receiving end UE only feeds back the HARQ information of the current data on the PSFCH feedback resource corresponding to the data.

OneOrMoreFlag=1 represents that feedback is enabled, which indicates that the receiving end UE feeds back the HARQ information of all to-be-fed-back data by using the SCI and/or data in the delay T after the slot in which the PSFCH feedback resource corresponding to the data is located. All the to-be-fed-back data may refer to to-be-fed-back data that are configured via RRC or pre-configured (for example, the indicated slot index(es) of slot(s) of which feedback is required by the transmitting end UE).

The transmitting end UE indicates OneOrMoreFlag=1 and then receives the HARQ information fed back by the receiving end UE in the delay T after the PSFCH slot corresponding to the PSSCH. If the transmitting end UE does not receive the feedback information of these to-be-fed-back slots in the feedback delay T, the transmitting end UE determines the HARQ information of these to-be-fed-back data as NACK.

In an embodiment, the first feedback indication information includes 1-bit indication information, and the second feedback indication information includes to-be-fed-back HARQ process indication information or to-be-fed-back HARQ process group index indication information.

The 1-bit indication information is used for indicating that feedback information on the PSFCH feedback resource includes one of the following: feedback information of an HARQ process corresponding to the current data, or feedback information of an HARQ process corresponding to the current data and a specified HARQ process.

Alternatively, the 1-bit indication information is used for indicating that feedback information on the PSFCH feedback resource includes one of the following: feedback information of an HARQ process corresponding to the current data, or feedback information of an HARQ process corresponding to the current data and feedback information of all to-be-fed-back HARQ processes, other than the HARQ process corresponding to the current data, in a specified HARQ process group.

The to-be-fed-back HARQ process indication information is used for indicating a process number of a specified HARQ process.

The to-be-fed-back HARQ process group index indication information is used for indicating an HARQ process in a specified HARQ process group.

In an example, it is assumed that SL communication maintains a total of N processes. In the case where HARQ feedback is enabled, the SCI contains one piece of indication information which is denoted by OneOrMoreFlag, and the indication information indicates that feedback information on the PSFCH feedback resource corresponding to a current PSSCH includes one of the following: only feeding back HARQ information of current data or feeding back HARQ information of data corresponding to a specified HARQ process.

The indication information is 1 bit.

In the case where the transmitting end UE requires the receiving end UE to only feed back the HARQ information of the current data, the OneOrMoreFlag in the SCI is set to 0. In the case where the transmitting end UE requires the receiving end UE to additionally feed back the HARQ information of the data corresponding to the specified HARQ process, the OneOrMoreFlag is set to 1.

The specified HARQ process is indicated by the transmitting end UE to the receiving end UE through a higher-layer signaling.

In an embodiment, the first feedback indication information includes bitmap indication information.

The bitmap indication information is used for indicating that the feedback information on the PSFCH feedback resource includes that: bits in a bitmap is in a one-to-one correspondence with HARQ processes, and it is represented that feedback information of a HARQ process is fed back on the PSFCH feedback resource when a bit corresponding to the HARQ process in the bitmap is set to 1.

In an example, it is assumed that SL communication maintains a total of N processes. When HARQ feedback is enabled, the SCI contains one piece of indication information which is denoted by HARQbitmap, and the indication information indicates feedback information on the PSFCH feedback resource corresponding to a current PSSCH.

The HARQbitmap is N bits, and the N bits are in a one-to-one correspondence with the N HARQ processes. When a bit corresponding to an HARQ process in the N bits is set to 1, it is indicated that the HARQ information of the process is fed back on a PSFCH feedback resource corresponding to current data.

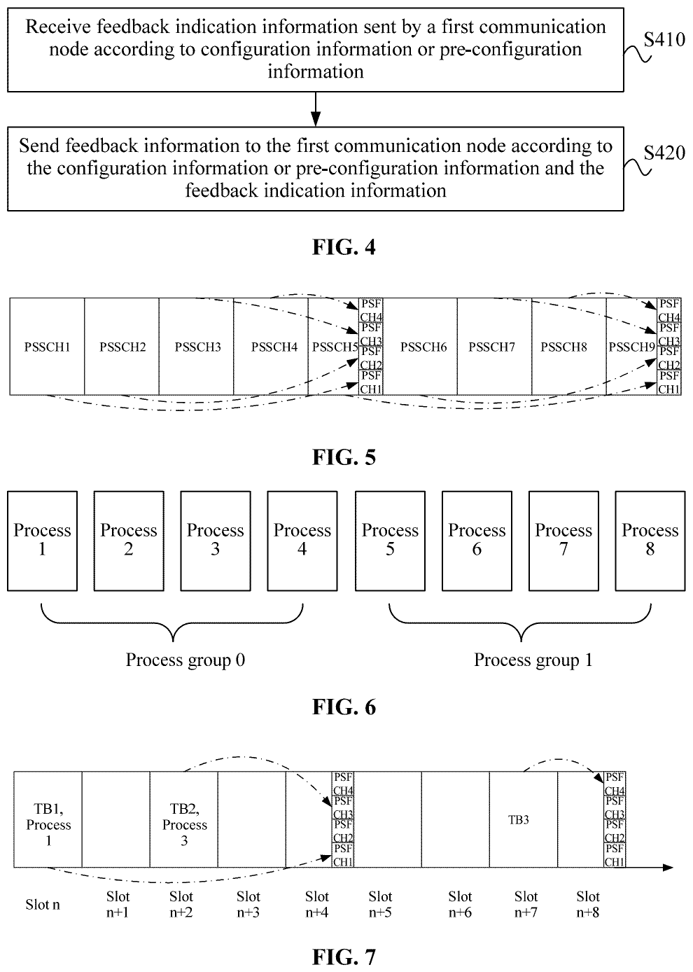

In an embodiment, FIG. 4 is another flowchart of an information transmission method according to an embodiment of the present application. The embodiment may be executed by an information transmission device. The information transmission device may be a second communication node. For example, the second communication node may be a receiving end UE. As shown in FIG. 4, the embodiment includes S410 and S420.

In S410, feedback indication information sent by a first communication node according to configuration information or pre-configuration information is received.

In S420, feedback information is sent to the first communication node according to the configuration information or pre-configuration information and the feedback indication information.

In an embodiment, the feedback indication information includes at least one of the following: first feedback indication information indicated in physical layer control information or second feedback indication information indicated in a higher-layer signaling.

In an embodiment, the operation of sending the feedback information to the first communication node according to the configuration information or pre-configuration information and the feedback indication information includes one of the following operations of:
sending the feedback information to the first communication node on a PSFCH feedback resource according to the configuration information or pre-configuration information and the first feedback indication information;
sending the feedback information to the first communication node in a feedback delay by using a sidelink data channel and/or a sidelink control channel according to the configuration information or pre-configuration information, the first feedback indication information and the second feedback indication information;
sending the feedback information to the first communication node on a PSFCH feedback resource according to the configuration information or pre-configuration information, the first feedback indication information and the second feedback indication information; or
sending the feedback information to the first communication node in a feedback delay by using a sidelink data channel and/or a sidelink control channel according to the configuration information or pre-configuration information and the first feedback indication information.

In an embodiment, the first feedback indication information is indication information in an SCI. The first feedback indication information includes at least one of the following: 1-bit indication information, bitmap indication information, to-be-fed-back HARQ process group index indication information, SL-SAI indication information or NFI indication information.

In an embodiment, the second feedback indication information is indication information carried in a higher layer on a sidelink. The second feedback indication information includes one of the following: to-be-fed-back HARQ process indication information, to-be-fed-back HARQ process group index indication information, to-be-fed-back slot indication information or to-be-fed-back slot group index indication information.

In an embodiment, the configuration information or pre-configuration information includes one of the following: information for configuring K groups of HARQ processes, where K is a positive integer greater than or equal to 1; or a feedback delay.

In an embodiment, the first feedback indication information includes 1-bit indication information. The 1-bit indication information is used for indicating that the feedback information on the PSFCH feedback resource includes one of the following: feedback information of an HARQ process corresponding to current data, or feedback information of all to-be-fed-back HARQ processes in an HARQ process group in which an HARQ process corresponding to current data is located.

In an example, it is assumed that SL communication maintains a total of N processes, and the N processes are grouped into K groups. In the case where HARQ feedback is enabled, the SCI contains one piece of indication information which is denoted by OneOrMoreFlag, and the indication information indicates that the feedback information on the PSFCH feedback resource corresponding to a current PSSCH includes one of the following: only feeding back the HARQ information of the HARQ process corresponding to the current data, or feeding back HARQ information of all data in the HARQ process group in which the HARQ process corresponding to the current data is located.

The receiving end UE receives the indication of an SCI, and if OneOrMoreFlag=0, the receiving end UE only feeds back on the PSFCH feedback resource corresponding to the current data the HARQ information of the data indicated by the current SCI.

If OneOrMoreFlag=1, the receiving end UE feeds back on a PSFCH feedback resource corresponding to the current data the HARQ information of all data in the HARQ process group in which the HARQ process of the current data is located. The pieces of feedback information corresponding to processes are sorted in an order of process numbers from smallest to largest or from largest to smallest, and the feedback information corresponding to each of the processes is in a one-to-one correspondence with data of each HARQ process in the HARQ process group in which the each of the processes is located.

In the embodiment, SL communication maintains a total of N processes, and the N processes are grouped into K groups that are configured per resource pool, are pre-configured or are configured per UE through a PC5 RRC signaling.

In an embodiment, the first feedback indication information includes to-be-fed-back HARQ process group index indication information. The to-be-fed-back HARQ process group index indication information is represented by a code point, and the number of code points is related to the number of HARQ process groups.

The to-be-fed-back HARQ process group index indication information is used for indicating that feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

One code point is used for indicating feeding back the feedback information of the HARQ process corresponding to the current data, and other code points are in a one-to-one correspondence with group indexes of the HARQ process groups.

In an embodiment, the grouping manner of the HARQ process groups includes one of the following operations: K groups of HARQ processes are directly pre-configured or configured, or the total number of HARQ processes and the number of processes in an HARQ process group are pre-configured or configured, and K groups of HARQ processes are determined according to the number of processes in the HARQ process group and the total number of HARQ processes.

In an example, it is assumed that SL communication maintains a total of N processes, and the N processes are grouped into K groups. In the case where HARQ feedback is enabled, the SCI contains one piece of indication information, and the indication information indicates that feedback information on the PSFCH feedback resource corresponding to a current PSSCH includes one of the following: only feeding back HARQ information of an HARQ process corresponding to current data; if an HARQ process corresponding to current data is included in an i-th HARQ process group, feeding back all pieces of HARQ information in the i-th HARQ process group indicated; or if an HARQ process corresponding to current data is not included in an i-th HARQ process group, feeding back HARQ information of all HARQ processes in the i-th HARQ process group indicated and HARQ information of the HARQ process corresponding to the current data.

The indication information is log₂(K+1) rounded up. One code point is used for indicating only feeding back the HARQ information of the HARQ process corresponding to the current data, and other code points are in a one-to-one correspondence with group indexes of K HARQ process groups.

In the case where the receiving end UE receives a code point indicated in the SCI, it is identified whether the to-be-fed-back data corresponding to the code point is for only feeding back the HARQ information of the current data or for feeding back HARQ information of all the to-be-fed-back data in the i-th group, in addition to the HARQ information of the current data, required by the receiving end UE. In response to determining that the receiving end UE also requires to feed back the HARQ information of all the to-be-fed-back data in the i-th group, in addition to the HARQ information of the current data, HARQ feedback information of the corresponding data is fed back on the PSFCH feedback resource corresponding to the data resource indicated by the current SCI according to the indication information.

The HARQ feedback information corresponding to processes is sorted in an order of process numbers from smallest to largest or from largest to smallest, and the HARQ feedback information corresponding to processes is in a one-to-one correspondence with data of HARQ processes.

If no K groups of processes are configured or pre-configured, K is equal to 1 by default, and then the HARQ process group index information is not required to be indicated.

In the embodiment, SL communication maintains a total of N processes, and the N processes are grouped into K groups that are configured per resource pool, are pre-configured or are configured per UE through a PC5 RRC signaling.

In an embodiment, the first feedback indication information includes one of the following: 1-bit indication information, SL-SAI indication information or NFI indication information.

The 1-bit indication information is used for indicating that feedback information on the PSFCH feedback resource includes one of the following: feedback information of an HARQ process corresponding to current data, or feedback information of an HARQ process corresponding to current data and all to-be-fed-back data; where the to-be-fed-back data is before the current data and refers to all data needing feedback and determined according to at least one of an SL-SAI or an NFI.

The SL-SAI indication information is used for indicating a count index of an SCI in a PSCCH.

The NFI indication information is used for indicating whether the current SL-SAI indication information is a new count index.

In an example, HARQ information of data for which feedback is failure is generated and fed back according to an SL-SAI index, OneOrMoreFlag and an NFI indicated in the SCI.

A field in the SCI indicates one of the following: 1-bit indication information for indicating whether to only feed back HARQ information of an HARQ process corresponding to the current data, which is denoted by OneOrMoreFlag; SL-SAI indication information for indicating the total number of PSSCHs until the data indicated by the current SCI; or NFI indication information of 1 bit used for indicating whether the SL-SAI is a new count or an old count, where the NFI indicates that the SL-SAI is the new count when flipping.

OneOrMoreFlag=1 indicates that the HARQ information of all the to-be-fed-back data is fed back, and the data are the PSSCHs counted by the SAL. OneOrMoreFlag=0 indicates that only the HARQ information of the current data is fed back.

Whether the NFI is flipped represents whether the current SAI is a new count index or an old count index. Once the NFI is flipped, the count of the current SAI restarts, and the HARQs saved for the PSSCHs corresponding to the SAI count before the flipping are cleared and are no longer fed back.

When OneOrMoreFlag in the SCI received by the receiving end UE is set to 0, the receiving end UE only feeds back the HARQ information of the data indicated by the current SCI on a feedback resource corresponding to the current data.

When OneOrMoreFlag in the SCI received by the receiving end UE is set to 1, the receiving end UE determines, according to the counter SL-SAI of the current SCI and the new/old count indication NFI, to feed back the HARQ information of all to-be-fed-back data on a feedback resource corresponding to the current data.

Assuming that the count by the SL-SAI is N, N-bit HARQ feedback information is fed back on a feedback resource corresponding to the current data, where the N-bit feedback information is sorted according to the SL-SAI index and is in a one-to-one correspondence with data corresponding to the SL-SAI.

In an embodiment, the configuration information or pre-configuration information includes a feedback delay, the first feedback indication information includes 1-bit indication information, and the second feedback indication information includes to-be-fed-back HARQ process indication information or to-be-fed-back HARQ process group index indication information.

The 1-bit indication information is used for indicating an enabling situation of sending feedback information in the feedback delay. The to-be-fed-back HARQ process indication information is used for indicating process numbers of all processes, for which HARQ is to be fed back, before current data. The to-be-fed-back HARQ process group index indication information is used for indicating HARQ processes in all process groups, for which HARQ is to be fed back, before current data.

The starting position of the feedback delay includes one of the following: a slot in which a PSFCH feedback resource corresponding to current data is located, a first slot after a slot in which a PSFCH feedback resource corresponding to current data is located, a slot in which a data resource or a control resource is located, or a first slot after a slot in which a data resource or a control resource is located.

In an example, a feedback delay T is configured by a higher layer or pre-configured, and the feedback delay starts from the slot in which the first PSFCH feedback resource corresponding to a PSSCH is located. The receiving end UE sends the SCI and/or data for HARQ feedback in the feedback delay window T after the PSFCH resource.

When the receiving end UE receives a flag, which represents enabling feedback in the delay, in the SCI and the flag is OneOrMoreFlag=0, the receiving end UE feeds back the HARQ of the current data on a PSFCH corresponding to the data.

If the receiving end UE receives a flag, which represents enabling feedback in the delay, in the SCI and the flag is OneOrMoreFlag=1, the receiving end UE feeds back the HARQs of all to-be-fed-back data by using the SCI and/or data in the delay T after the slot in which the PSFCH resource corresponding to the data is located. All the to-be-fed-back data may refer to data of all processes or specified to-be-fed-back data indicated by the SCI (for example, the data for indicating the process number(s) of process(es) of which feedback is required by the transmitting end UE or the data counted by the SL-SAI).

The HARQs of all to-be-fed-back data may be in the SCI, or may be placed in a data channel by using the MAC CE and then fed back.

The feedback delay T in the method is configured per resource pool, is pre-configured or is configured per UE through a PC5 RRC signaling.

In an example, one feedback delay T is configured by a higher layer or pre-configured, and the feedback delay starts from the slot in which the first PSFCH feedback resource corresponding to a PSSCH is located. The receiving end UE sends the SCI and/or data for HARQ feedback in the feedback delay window T after the PSFCH resource.

When the receiving end UE receives a flag, which represents enabling feedback in the delay, in the SCI and the flag is OneOrMoreFlag=0, the receiving end UE feeds back the HARQ of the current data on a PSFCH corresponding to the data.

If the receiving end UE receives a flag, which represents enabling feedback in the delay, in the SCI and the flag is OneOrMoreFlag=1, the receiving end UE feeds back the HARQs of all to-be-fed-back data by using the SCI and/or data in the delay T after the slot in which the PSFCH resource corresponding to the data is located. All the to-be-fed-back data may refer to to-be-fed-back data that are configured via RRC or pre-configured (for example, the indicated process number(s) of process(es) of which feedback is required by the transmitting end UE).

The HARQ information of all to-be-fed-back data may be in the SCI or may be placed in a data channel by using the MAC CE and then fed back.

The feedback delay T in the method is configured per resource pool, is pre-configured or is configured per UE through a PC5 RRC signaling.

In an embodiment, the configuration information or pre-configuration information includes a feedback delay, the first feedback indication information includes 1-bit indication information, and the second feedback indication information includes to-be-fed-back slot indication information or to-be-fed-back slot group index indication information.

The 1-bit indication information is used for indicating an enabling situation of sending feedback information in the feedback delay. The to-be-fed-back slot indication information is used for indicating indexes of all slots, for which feedback is to be performed, before a slot corresponding to current data. The to-be-fed-back slot group index indication information is used for indicating HARQ processes in to-be-fed-back slots in all slot groups, for which feedback is to be performed, before a slot corresponding to current data.

The starting position of the feedback delay includes one of the following: a slot in which a PSFCH feedback resource corresponding to current data is located, a first slot after a slot in which a PSFCH feedback resource corresponding to current data is located, a slot in which a data resource or a control resource is located, or a first slot after a slot in which a data resource or a control resource is located.

In an example, one feedback delay T is configured by a higher layer or pre-configured, and the feedback delay starts from the slot in which the first PSFCH feedback resource corresponding to a PSSCH is located. The receiving end UE sends the SCI and/or data for HARQ feedback in the feedback delay window T after the PSFCH resource.

When the receiving end UE receives a flag, which represents enabling feedback in the delay, in the SCI and the flag is OneOrMoreFlag=0, the receiving end UE feeds back the HARQ of the current data on a PSFCH corresponding to the data.

If the receiving end UE receives a flag, which represents enabling feedback in the delay, in the SCI and the flag is OneOrMoreFlag=1, the receiving end UE feeds back the HARQs of all to-be-fed-back data by using the SCI and/or data in the delay T after the slot in which the PSFCH resource corresponding to the data is located. All the to-be-fed-back data may refer to data in all to-be-fed-back slots or specified to-be-fed-back data indicated by the SCI (for example, the data indicating the slot index(es) of slot(s) of which feedback is required by the transmitting end UE or the data counted by the SL-SAI).

The HARQs of all to-be-fed-back data may be in the SCI or may be placed in a data channel by using the MAC CE and then fed back.

The feedback delay T in the method is configured per resource pool, is pre-configured or is configured per UE through a PC5 RRC signaling.

In an example, one feedback delay T is configured by a higher layer or pre-configured, and the feedback delay starts from the slot in which the first PSFCH feedback resource corresponding to a PSSCH is located. The receiving end UE sends the SCI and/or data for HARQ feedback in the feedback delay window T after the PSFCH resource.

When the receiving end UE receives a flag, which represents enabling feedback in the delay, in the SCI and the flag is OneOrMoreFlag=0, the receiving end UE feeds back the HARQ of the current data on a PSFCH corresponding to the data.

If the receiving end UE receives a flag, which represents enabling feedback in the delay, in the SCI and the flag is OneOrMoreFlag=1, the receiving end UE feeds back the HARQs of all to-be-fed-back data by using the SCI and/or data in the delay T after the slot in which the PSFCH resource corresponding to the data is located. All the to-be-fed-back data may refer to to-be-fed-back data that are configured via RRC or pre-configured (for example, the data indicating the slot index(es) of slot(s) of which feedback is required by the transmitting end UE).

The HARQs of all to-be-fed-back data may be in the SCI or may be placed in a data channel by using the MAC CE and then fed back.

The feedback delay T in the method is configured per resource pool, is pre-configured or is configured per UE through a PC5 RRC signaling.

In an embodiment, the first feedback indication information includes 1-bit indication information, and the second feedback indication information includes to-be-fed-back HARQ process indication information or to-be-fed-back HARQ process group index indication information.

The 1-bit indication information is used for indicating that feedback information on the PSFCH feedback resource includes one of the following: feedback information of an HARQ process corresponding to current data, or feedback information of HARQ processes corresponding to current data and a specified HARQ process.

Alternatively, the 1-bit indication information is used for indicating that feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

The to-be-fed-back HARQ process indication information is used for indicating a process number of a specified HARQ process.

The to-be-fed-back HARQ process group index indication information is used for indicating an HARQ process in a specified HARQ process group.

In an example, it is assumed that SL communication maintains a total of N processes. In the case where HARQ feedback is enabled, the SCI contains one piece of indication information which is denoted by OneOrMoreFlag, and the indication information indicates that feedback information on the feedback resource corresponding to a current PSSCH includes one of the following: only feeding back HARQ information of current data or feeding back HARQ information of data corresponding to a specified HARQ process.

The indication information is 1 bit.

When OneOrMoreFlag in the SCI received by the receiving end UE is set to 0, the receiving end UE only feeds back the HARQ information of the current data on the PSFCH resource corresponding to the current data.

When OneOrMoreFlag in the SCI received by the receiving end UE is set to [[0]], the receiving end UE feeds back the HARQ feedback information of the data corresponding to a specified HARQ process on the PSFCH resource corresponding to the current data. The specified HARQ process is indicated to the receiving end UE by the transmitting end UE through a higher-layer signaling.

In an embodiment, the first feedback indication information includes bitmap indication information. The bitmap indication information is used for indicating that feedback information on the PSFCH feedback resource includes that: bits in a bitmap is in a one-to-one correspondence with HARQ processes, and when a bit corresponding to an HARQ process in the bitmap is set to 1, it is represented that feedback information of the corresponding HARQ process is fed back on the PSFCH feedback resource.

In an example, it is assumed that SL communication maintains a total of N processes. When HARQ feedback is enabled, the SCI contains one piece of indication information which is denoted by HARQbitmap, and the information indicates feedback information on a feedback resource corresponding to a current PSSCH.

The HARQbitmap is N bits, and the N bits are in a one-to-one correspondence with N HARQ processes. When a bit corresponding to an HARQ process in the N bits is set to 1, it is represented that the HARQ information of the process is fed back on a PSFCH feedback resource corresponding to current data.

The receiving end UE feeds back data in the HARQ processes corresponding to bits that are set to 1 on the PSFCH resource corresponding to the current data according to the value of HARQbitmap in the received SCI.

In the above embodiments, in the feedback information the HARQ process corresponding to current data and the to-be-fed-back HARQ process(es) belong to the same HARQ process group. The feedback information corresponding to HARQ processes is sorted in an order of process numbers from smallest to largest or from largest to smallest, and the feedback information corresponding to each of the HARQ processes is in a one-to-one correspondence with data of each HARQ process in an HARQ process group in which each of the HARQ processes is located.

In the above embodiments, in the feedback information the HARQ process corresponding to the current data and to-be-fed-back HARQ process(es) do not belong to the same HARQ process group. The feedback information of the HARQ process corresponding to the current data is located before or after the feedback information of all to-be-fed-back HARQ processes. The feedback information of the to-be-fed-back HARQ processes is sorted in an order of process numbers from smallest to largest or from largest to smallest, and the feedback information of the to-be-fed-back HARQ processes is in a one-to-one correspondence with data of HARQ processes.

In the above embodiments, the feedback information is sorted in an order of process numbers from smallest to largest or from largest to smallest, and the feedback information is in a one-to-one correspondence with data of each to-be-fed-back HARQ process.

In the above embodiments, the feedback information is sorted in an order of sidelink counter assignment index (SL-SAI) values from smallest to largest or from largest to smallest, and the feedback information is in a one-to-one correspondence with each to-be-fed-back data.

In the above embodiments, the feedback information is sorted in an order of slot index values from smallest to largest or from largest to smallest, and the feedback information is in a one-to-one correspondence with data in each to-be-fed-back slot.

In the above embodiments, each feedback bit in the feedback information is in a one-to-one correspondence with each to-be-fed-back data.

The feedback bit generates ACK information or NACK information according to the receiving situation of to-be-fed-back data. For an unreceived to-be-fed-back HARQ process, an unreceived to-be-fed-back slot or unreceived to-be-fed-back data, the feedback bit generates NACK information.

The feedback information includes at least one feedback bit.

The to-be-fed-back data may be data enabled HARQ feedback that has been sent by the first communication node but the corresponding HARQ feedback of which has not been received yet.

The to-be-fed-back HARQ process may be the process index of the process carrying data enabled HARQ feedback that has been sent by the first communication node but the corresponding HARQ feedback of which has not been received yet.

The to-be-fed-back slot may be the slot index of the slot carrying data enabled HARQ feedback that has been sent by the first communication node but the corresponding HARQ feedback of which has not been received yet.

In an embodiment, it is assumed that a PSFCH period in an SL resource pool is 4 SL slots, a minimum feedback delay is 1 SL slot, and only one subchannel exists in the frequency domain. FIG. 5 is a schematic diagram of feedback of feedback information according to an embodiment of the present application. As shown in FIG. 5, PFSCH feedback is performed every 4 SL slots.

In an example, the SL communication initializes 8 HARQ processes for data sending, and these processes are divided into {process 1, process 2, process 3, process 4, process 5, process 6, process 7, process 8}.

FIG. 6 is a schematic diagram of an allocation of HARQ process groups according to an embodiment of the present application. As shown in FIG. 6, these processes are divided into two groups: group 0 of {process 1, process 2, process 3, process 4} and group 1 of {process 5, process 6, process 7, process 8}.

FIG. 7 is a schematic diagram of an allocation of HARQ processes and feedback resources according to an embodiment of the present application. As shown in FIG. 7, the transmitting end UE has data to send in different PSFCH periods. The transmitting end UE transmits TB1 by using process 1 in slot n, transmits TB2 by using process 3 in slot n+2, and transmits TB3 in slot n+7. Feedback resources corresponding to TB1 and TB2 are in slot n+4, and a feedback resource corresponding to TB3 is in slot n+8.

In an example, adopting the allocation scheme of FIGS. 6 and 7, the transmission procedure of the transmitting end UE is described below by taking an example where the first feedback indication information includes 1-bit indication information.

The SCI corresponding to TB1 data indicates process number 1, and OneOrMoreFlag=0 which represents that only HARQ information of the current data is fed back on the feedback resource corresponding to TB1.

The SCI corresponding to TB2 data indicates process number 3, and OneOrMoreFlag=0 which represents that only HARQ information of the current data is fed back on the feedback resource corresponding to TB2.

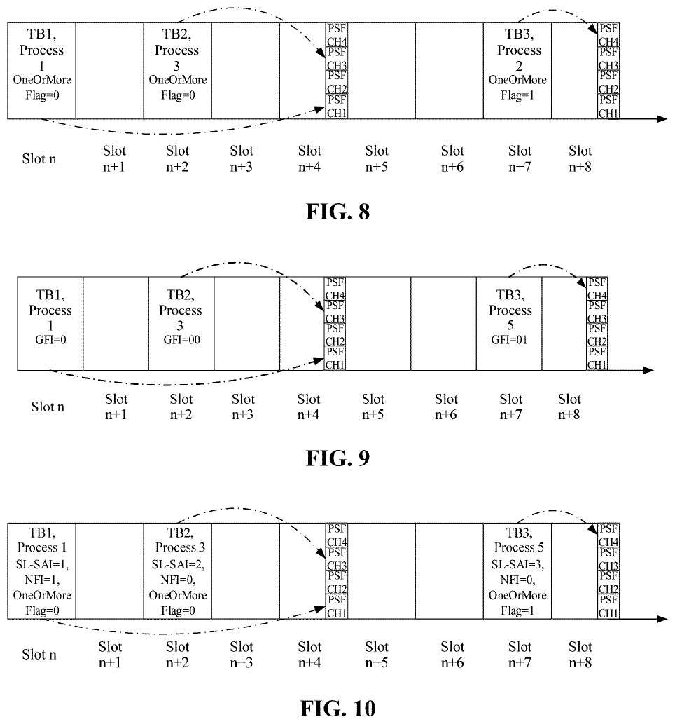

FIG. 8 is another schematic diagram of an allocation of HARQ processes and feedback resources according to an embodiment of the present application. For TB1 and TB2, when the transmitting end UE does not receive feedback information from the receiving end UE on the corresponding feedback resource in slot n+4 but still has TB3 for data sending in slot n+7, the transmitting end UE allocates process 2 to TB3, as well as indicates in the SCI the process ID and OneOrMoreFlag=1 which represents that the receiving end UE feeds back on the feedback resource corresponding to TB3 HARQ feedback information of all data of the group in which process 2 is located. The transmitting end UE receives the HARQ feedback information of four processes {process 1, process 2, process 3, process 4} on the feedback resource corresponding to TB3.

In an example, adopting the allocation scheme of FIGS. 6 and 7, the transmission procedure of the transmitting end UE is described below by taking an example where the first feedback indication information includes to-be-fed-back HARQ process group index indication information and the to-be-fed-back HARQ process group index indication information is represented by a code point.

The HARQ processes are grouped into two groups and the two groups are numbered group 0 and group 1, and the two groups are represented in the SCI by 2 bits obtained by rounding log₂(2+1), which is noted as GFI (group flag indicator).

GFI=00 indicates that only HARQ information of current data is fed back on a feedback resource corresponding to the current data indicated by the received SCI.GFI=01 indicates that, in addition to HARQ information of current data, HARQ information of all other to-be-fed-back data in the HARQ process group 0 needs to be fed back on a feedback resource corresponding to the current data indicated by the received SCI.

GFI=10 indicates that, in addition to HARQ information of current data, HARQ information of all other to-be-fed-back data in the HARQ process group 1 needs to be fed back on a feedback resource corresponding to the current data indicated by the received SCI.

GFI=11 is a reserved bit.

The SCI corresponding to the TB1 data indicates process number 1 and GFI=00 which represents that only HARQ information of the current data is fed back on the feedback resource corresponding to TB1. The SCI corresponding to the TB2 data indicates process number 3 and GFI=00 which represents that only HARQ information of the current data is fed back on the feedback resource corresponding to TB2.

FIG. 9 is another schematic diagram of an allocation of HARQ processes and feedback resources according to an embodiment of the present application. As shown in FIG. 9, for TB1 and TB2, when the transmitting end UE does not receive feedback information from the receiving end UE on the corresponding feedback resource in slot n+4 but still has TB3 for data sending in slot n+7, the transmitting end UE allocates process 5 to TB3, as well as indicates in the SCI the process ID and GFI=01 which represents that the receiving end UE on the feedback resource corresponding to TB3 not only feeds back HARQ information of TB3 but also feeds back HARQ feedback information of all data of group 0.

The transmitting end UE receives the HARQ feedback information of four processes {process 1, process 2, process 3, process 4} and feedback information of process 5 corresponding to TB3 on the feedback resource corresponding to TB3, a total of 5 bits of feedback information.

In an example, adopting the allocation scheme of FIGS. 6 and 7, the transmission procedure of the transmitting end UE is described below by taking an example where the first feedback indication information includes at least one of the following: 1-bit indication information, SL-SAI indication information or NFI indication information.

The SCI corresponding to TB1 data indicates process number 1, OneOrMoreFlag=0 which represents that only HARQ information of the current data is fed back on the feedback resource corresponding to TB1, NFI=0, and SL-SAI=1.

The SCI corresponding to data TB2 indicates process number 3, OneOrMoreFlag=0 which represents that only HARQ information of the current data is fed back on the feedback resource corresponding to TB2, NFI=0, and SL-SAI=2.

FIG. 10 is another schematic diagram of an allocation of HARQ processes and feedback resources according to an embodiment of the present application. As shown in FIG. 10, for TB1 and TB2, when the transmitting end UE does not receive feedback information from the receiving end UE on the corresponding feedback resource in slot n+4 but still has TB3 for data sending in slot n+7, the transmitting end UE allocates process 5 to TB3, as well as indicates in the SCI the process ID, OneOrMoreFlag=1, NFI=0 and SL-SAI=3, which represents that the receiving end UE on the feedback resource corresponding to TB3 not only feeds back HARQ information of TB3 but also feeds back HARQ feedback information of data corresponding to SL-SAI=1 and SL-SAI=2. The transmitting end UE receives, on the feedback resource corresponding to TB3, feedback information of three data of TB1, TB2 and TB3, a total of 3 bits of feedback information.

In an example, adopting the allocation scheme of FIGS. 6 and 7, the transmission procedure of the transmitting end UE is described below by taking an example where the configuration information or pre-configuration information includes a feedback delay, the first feedback indication information includes 1-bit indication information, and the second feedback indication information includes to-be-fed-back HARQ process indication information or to-be-fed-back HARQ process group index indication information.

An additional HARQ feedback delay is configured or pre-configured to be T in a resource pool. The SCI corresponding to TB1 data indicates process number 1 and OneOrMoreFlag=0 which represents that only HARQ information of the current data is fed back on the feedback resource corresponding to TB1. The SCI corresponding to TB2 data indicates process number 3 and OneOrMoreFlag=0 which represents that only HARQ information of the current data is fed back on the feedback resource corresponding to TB2.

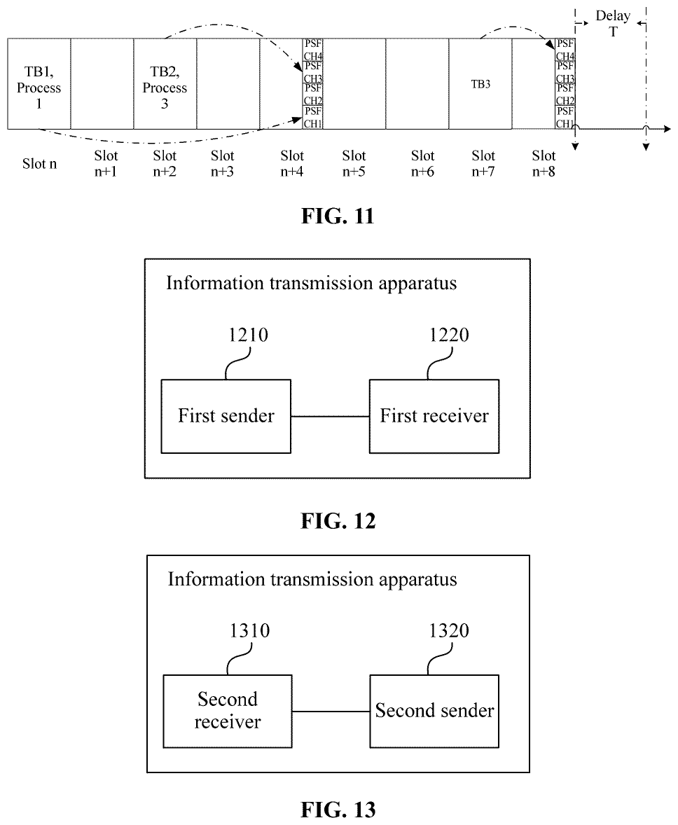

FIG. 11 is another schematic diagram of an allocation of HARQ processes and feedback resources according to an embodiment of the present application. As shown in FIG. 11, for TB1 and TB2, when the transmitting end UE does not receive feedback information from the receiving end UE on the corresponding feedback resource in slot n+4 but still has TB3 for data sending in slot n+7, the transmitting end UE allocates process 2 to TB3, as well as indicates in the SCI the process ID and OneOrMoreFlag=1. The transmitting end UE notifies, through a higher-layer signaling, the receiving end UE of the numbers {process 1, process 3} of processes that need to re-feed back HARQ information, which represents that the receiving end UE re-feeds back HARQ information of process 1 and HARQ information of process 3 by using the SCI and/or data in the delay T starting from the slot in which the PSFCH feedback resource corresponding to TB3 is located.

In an example, adopting the allocation scheme of FIGS. 6 and 7, the transmission procedure of the transmitting end UE is described below by taking an example where the first feedback indication information includes 1-bit indication information and the second feedback indication information includes to-be-fed-back HARQ process indication information or to-be-fed-back HARQ process group index indication information.

The SCI corresponding to TB1 data indicates process number 1 and OneOrMoreFlag=0 which represents that only HARQ information of the current data is fed back on the feedback resource corresponding to TB1.

The SCI corresponding to TB2 data indicates process number 3 and OneOrMoreFlag=0 which represents that only HARQ information of the current data is fed back on the feedback resource corresponding to TB2.

For TB1 and TB2, when the transmitting end UE does not receive feedback information from the receiving end UE on the corresponding feedback resource in slot n+4 but still has TB3 for data sending in slot n+7, the transmitting end UE allocates process 2 to TB3, as well as indicates in the SCI the process ID and OneOrMoreFlag=1. The transmitting end UE notifies, through a higher-layer signaling, the receiving end UE of the processes {process 1, process 3} of data to-be-fed-back, which represents that the receiving end UE needs to feed back HARQ information of TB3, HARQ information of TB1 and HARQ information of TB2 on the PSFCH feedback resource corresponding to TB3, as shown in FIG. 11.

In an example, adopting the allocation scheme of FIGS. 6 and 7, the transmission procedure of the transmitting end UE is described below by taking an example where the first feedback indication information includes bitmap indication information.

The SCI corresponding to TB1 data indicates process number 1 and HARQbitmap=1000 0000 which represents that only HARQ information of the current data (TB1, process 1) is fed back on the feedback resource corresponding to TB1.

The SCI corresponding to data TB2 indicates process number 3 and HARQbitmap=0010 0000 which represents that only HARQ information of the current data (TB2, process 3) is fed back on the feedback resource corresponding to TB2.

For TB1 and TB2, when the transmitting end UE does not receive feedback information from the receiving end UE on a corresponding feedback resource in slot n+4 but still has TB3 for data sending in slot n+7, the transmitting end UE allocates process 2 to TB3, as well as indicates in the SCI the process ID2 and HARQbitmap=1110 0000, which represents that the receiving end UE needs to feed back HARQ information of process 1, HARQ information of process 2 and HARQ information of process 3 on the PSFCH feedback resource corresponding to TB3, as shown in FIG. 11.

In an example, adopting the allocation scheme of FIGS. 6 and 7, the transmission procedure of the receiving end UE is described below by taking an example where the first feedback indication information includes 1-bit indication information.

The receiving end UE receives TB1 and TB2 and generates HARQ feedback information corresponding to TB1 and TB2 to prepare to send. However, the receiving end UE fails to send the generated HARQ feedback information in slot n+4 due to some causes such as an LBT failure, a priority cause or a power cause, and then saves the HARQ information of TB1 and the HARQ information of TB2 and waits for the next sending opportunity.

When TB3 is received in slot n+7, it is determined that process 2 of TB3 belongs to the same group as the process of TB1 and the process of TB2, and it is indicated in the SCI of TB3 that OneOrMoreFlag=1 which represents that the HARQ feedback information of all the data in the group in which process 2 is located is fed back on the feedback resource corresponding to TB3. The receiving end UE generates 4 bits of feedback information for {process 1, process 2, process 3, process 4} in conjunction with the receiving situation of TB3 and the previously saved HARQ information of TB1 and TB2. Since no data is received in process 4, the HARQ feedback information corresponding to process 4 is filled with NACK. The receiving end UE sequentially generates 4 bits of HARQ feedback information according to the process indexes and feeds back the 4 bits of HARQ feedback information to the transmitting end UE on the feedback resource corresponding to TB3.

In an example, adopting the allocation scheme of FIGS. 6 and 7, the transmission procedure of the receiving end UE is described below by taking an example where the first feedback indication information includes to-be-fed-back HARQ process group index indication information and the to-be-fed-back HARQ process group index indication information is represented by a code point.

The receiving end UE receives TB1 and TB2 and generates HARQ feedback information corresponding to TB1 and TB2 to prepare to send. However, the receiving end UE fails to send the generated HARQ feedback information in slot n+4 due to some causes such as an LBT failure, a priority cause or a power cause, and then saves the HARQ information of TB1 and the HARQ information of TB2 and waits for the next sending opportunity.

When TB3 is received in slot n+7, it is indicated in the SCI of TB3 that OneOrMoreFlag=1, the number of the process corresponding to the TB3 is 5 and GFI=01, which represents that the HARQ feedback information of all the process data in group 0 is fed back on the feedback resource corresponding to TB3. Therefore, the receiving end UE generates additional 4 bits of feedback information for {process 1, process 2, process 3, process 4} in conjunction with the receiving situation of TB3 and the previously saved HARQ information of TB1 and TB2. Since no data is received in process 4, the HARQ feedback information corresponding to process 4 is filled with NACK. The receiving end UE sequentially generates 4 bits of HARQ feedback information according to the process indexes in group 0, sorts the 4 bits of HARQ feedback information and 1 bit of HARQ feedback information corresponding to TB3 in an order of process indexes from smallest to largest, and feeds back 5 bits of information to the transmitting end UE on the feedback resource corresponding to TB3.

In an example, adopting the allocation scheme of FIGS. 6 and 7, the transmission procedure of the receiving end UE is described below by taking an example where the first feedback indication information includes at least one of the following: 1-bit indication information, SL-SAI indication information or NFI indication information.

The receiving end UE receives TB1 and TB2 and generates HARQ feedback information corresponding to TB1 and TB2 to prepare to send. However, the receiving end UE fails to send the generated HARQ feedback information in slot n+4 due to some causes such as an LBT failure, a priority cause or a power cause, and then saves the HARQ information of TB1 and the HARQ information of TB2 and waits for the next sending opportunity.

When TB3 is received in slot n+7, it is indicated in the SCI of TB3 that OneOrMoreFlag=1, NFI=0 without flipping and SL-SAI=3, which represents that the HARQ feedback information of all the data counted in the SL-SAI is fed back on the feedback resource corresponding to TB3. Therefore, the receiving end UE generates 3 bits of feedback information for TB1, TB2 and TB3 according to SL-SAI indexes in conjunction with the receiving situation of TB3 and the previously saved HARQ information of TB1 and TB2, and feeds back the 3 bits of information to the transmitting end UE on the PSFCH feedback resource corresponding to TB3.

In an example, adopting the allocation scheme of FIGS. 6 and 7, the transmission procedure of the receiving end UE is described below by taking an example where the configuration information or pre-configuration information includes a feedback delay, the first feedback indication information includes 1-bit indication information and the second feedback indication information includes to-be-fed-back HARQ process indication information or to-be-fed-back HARQ process group index indication information.

The receiving end UE receives TB1 and TB2, where the SCI of TB1 indicates OneOrMoreFlag=0 and process number 1 and the SCI of TB2 indicates OneOrMoreFlag=0 and process number 3; and the receiving end UE generates HARQ feedback information corresponding to TB1 and TB2 to prepare to send. However, the receiving end UE fails to send the generated HARQ feedback information in slot n+4 due to some causes such as an LBT failure, a priority cause or a power cause, and then saves the HARQ information of TB1 and TB2 and waits for the next sending opportunity.

When TB3 is received in slot n+7, OneOrMoreFlag=1 and process number 2 are indicated in the SCI of TB3, and the receiving end UE receives the processes {process 1, process 3} of to-be-fed-back data which are indicated by the transmitting end UE; and based on the previous content, the receiving end UE re-feeds back, starting from the slot in which the PSFCH feedback resource corresponding to TB3 is located, the HARQ information of process 1 and the HARQ information of process 3 by using the SCI and/or data within the delay T.

T is configured per resource pool.

In an example, adopting the allocation scheme of FIGS. 6 and 7, the transmission procedure of the receiving end UE is described below by taking an example where the first feedback indication information includes 1-bit indication information and the second feedback indication information includes to-be-fed-back HARQ process indication information or to-be-fed-back HARQ process group index indication information.

The receiving end UE receives TB1 and TB2, where OneOrMoreFlag=0 and process number 1 are indicated in the SCI of TB1, and OneOrMoreFlag=0 and process number 3 are indicated in the SCI of TB2; and the receiving end UE generates HARQ feedback information corresponding to TB1 and TB2 to prepare to send. However, the receiving end UE fails to send the generated HARQ feedback information in slot n+4 due to some causes such as an LBT failure, a priority cause or a power cause, and then saves the HARQ information of TB1 and TB2 and waits for the next sending opportunity.

When TB3 is received in slot n+7, OneOrMoreFlag=1 and process number 2 are indicated in the SCI of TB3, and the receiving end UE receives the processes {process 1, process 3} of to-be-fed-back data which are indicated by the transmitting end UE; and based on the previous content, the receiving end UE feeds back the HARQ information of TB1 (process 1), the HARQ information of TB3 (process 2) and the HARQ information of TB2 (process 3) on the PSFCH feedback resource corresponding to TB3.

In an example, adopting the allocation scheme of FIGS. 6 and 7, the transmission procedure of the receiving end UE is described below by taking an example where the first feedback indication information includes bitmap indication information.

The receiving end UE receives TB1 and TB2, where HARQbitmap=1000 0000 and process number 1 are indicated in the SCI of TB1, and HARQbitmap=0010 0000 and process number 3 are indicated in the SCI of TB2; and the receiving end UE generates HARQ feedback information corresponding to TB1 and TB2 to prepare to send. However, the receiving end UE fails to send the generated HARQ feedback information in slot n+4 due to some causes such as an LBT failure, a priority cause and a power cause, and then saves the HARQ information of TB1 and TB2 and waits for the next sending opportunity.

When TB3 is received in slot n+7, the receiving end UE feeds back, according to HARQbitmap=1110 0000 and process number 2 indicated in the SCI of TB3, the HARQ information of TB1 (process 1), the HARQ information of TB3 (process 2) and the HARQ information of TB2 (process 3) on the PSFCH feedback resource corresponding to TB3. The feedback is sorted in an order of process indexes from smallest to largest.

In an embodiment, FIG. 12 is a block diagram of an information transmission apparatus according to an embodiment of the present application. The embodiment is applied to an information transmission device. The information transmission device is a first communication node. As shown in FIG. 12, the embodiment includes a first sender 1210 and a first receiver 1220.

The first sender 1210 is configured to send feedback indication information to a second communication node according to configuration information or pre-configuration information.

The first receiver 1220 is configured to receive feedback information sent by the second communication node according to the configuration information or pre-configuration information and the feedback indication information.

In an embodiment, the feedback indication information includes at least one of the following: first feedback indication information indicated in physical layer control information or second feedback indication information indicated in a higher-layer signaling.

In an embodiment, the operation of receiving the feedback information sent by the second communication node according to the configuration information or pre-configuration information and the feedback indication information includes one of the following operations of:
receiving feedback information sent by the second communication node on a corresponding PSFCH feedback resource according to the configuration information or pre-configuration information and the first feedback indication information;
receiving feedback information sent by the second communication node using a sidelink data channel and/or a sidelink control channel in a feedback delay according to the configuration information or pre-configuration information, the first feedback indication information and the second feedback indication information;
receiving feedback information sent by the second communication node on a corresponding PSFCH feedback resource according to the configuration information or pre-configuration information, the first feedback indication information and the second feedback indication information; or
receiving feedback information sent by the second communication node using a sidelink data channel and/or a sidelink control channel in a feedback delay according to the configuration information or pre-configuration information and the first feedback indication information.

In an embodiment, the first feedback indication information is indication information in an SCI. The first feedback indication information includes at least one of the following: 1-bit indication information, bitmap indication information, to-be-fed-back HARQ process group index indication information, SL-SAI indication information, or NFI indication information.

In an embodiment, the second feedback indication information is indication information carried in a higher layer on a sidelink. The second feedback indication information includes one of the following: to-be-fed-back HARQ process indication information, to-be-fed-back HARQ process group index indication information, to-be-fed-back slot indication information, or to-be-fed-back slot group index indication information.

In an embodiment, the configuration information or pre-configuration information includes one of the following: information for configuring K groups of HARQ processes, where K is a positive integer greater than or equal to 1; or a feedback delay.

In an embodiment, the first feedback indication information includes 1-bit indication information. The 1-bit indication information is used for indicating that feedback information on the PSFCH feedback resource at least includes one of the following: feedback information of an HARQ process corresponding to current data, or feedback information of all to-be-fed-back HARQ processes in an HARQ process group in which an HARQ process corresponding to current data is located.

In an embodiment, the first feedback indication information includes to-be-fed-back HARQ process group index indication information. The to-be-fed-back HARQ process group index indication information is represented by a code point, and the number of code points is related to the number of HARQ process groups.

The to-be-fed-back HARQ process group index indication information is used for indicating that feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

One code point is used for indicating feeding back the feedback information of the HARQ process corresponding to the current data, and other code points are in a one-to-one correspondence with group indexes of the HARQ process groups.

In an embodiment, the grouping manner of the HARQ process groups includes one of the following operations of:
directly pre-configuring or configuring K groups of HARQ processes; or
pre-configuring or configuring the total number of HARQ processes and the number of processes in an HARQ process group, and determining K groups of HARQ processes according to the number of processes in the HARQ process group and the total number of HARQ processes.

In an embodiment, the first feedback indication information includes one of the following: 1-bit indication information, SL-SAI indication information or NFI indication information.

The 1-bit indication information is used for indicating that the feedback information on the PSFCH feedback resource includes one of the following: feedback information of an HARQ process corresponding to current data, or feedback information of HARQ processes corresponding to current data and all to-be-fed-back data. The to-be-fed-back data is all data for which feedback is required and is before the current data and determined according to at least one of an SL-SAI or an NFI.

The SL-SAI indication information is used for indicating a count index of an SCI in a PSCCH.

The NFI indication information is used for indicating whether current SL-SAI indication information is a new count index.

In an embodiment, the configuration information or pre-configuration information includes a feedback delay, the first feedback indication information includes 1-bit indication information, and the second feedback indication information includes to-be-fed-back HARQ process indication information or to-be-fed-back HARQ process group index indication information.

The 1-bit indication information is used for indicating an enabling situation of sending feedback information in the feedback delay.

The to-be-fed-back HARQ process indication information is used for indicating process numbers of all processes, for which HARQ is to be fed back, before current data.

The to-be-fed-back HARQ process group index indication information is used for indicating HARQ processes in all process groups, for which HARQ is to be fed back, before current data.

The starting position of the feedback delay includes one of the following: a slot in which a PSFCH feedback resource corresponding to current data is located, a first slot after a slot in which a PSFCH feedback resource corresponding to current data is located, a slot in which a data resource or a control resource is located, or a first slot after a slot in which a data resource or a control resource is located.

In an embodiment, the configuration information or pre-configuration information includes a feedback delay, the first feedback indication information includes 1-bit indication information, and the second feedback indication information includes to-be-fed-back slot indication information or to-be-fed-back slot group index indication information.

The 1-bit indication information is used for indicating an enabling situation of sending feedback information in the feedback delay.

The to-be-fed-back slot indication information is used for indicating indexes of all slots, for which feedback is to be performed, before a slot corresponding to current data.

The to-be-fed-back slot group index indication information is used for indicating HARQ processes on to-be-fed-back slots in all slot groups, for which feedback is to be performed, before a slot corresponding to current data.

The starting position of the feedback delay includes one of the following: a slot in which a PSFCH feedback resource corresponding to current data is located, a first slot after a slot in which a PSFCH feedback resource corresponding to current data is located, a slot in which a data resource or a control resource is located, or a first slot after a slot in which a data resource or a control resource is located.

In an embodiment, the first feedback indication information includes 1-bit indication information, and the second feedback indication information includes to-be-fed-back HARQ process indication information or to-be-fed-back HARQ process group index indication information.

The 1-bit indication information is used for indicating that feedback information on the PSFCH feedback resource includes one of the following: feedback information of an HARQ process corresponding to current data, or feedback information of an HARQ process corresponding to current data and feedback information of a specified HARQ process.

Alternatively, the 1-bit indication information is used for indicating that feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

The to-be-fed-back HARQ process indication information is used for indicating a process number of a specified HARQ process.

The to-be-fed-back HARQ process group index indication information is used for indicating an HARQ process in a specified HARQ process group.

In an embodiment, the first feedback indication information includes bitmap indication information.

The bitmap indication information is used for indicating that feedback information on the PSFCH feedback resource includes that: bits in a bitmap is in a one-to-one correspondence with HARQ processes, and when a bit corresponding to an HARQ process in the bitmap is set to 1, it is represented that feedback information of the corresponding HARQ process is fed back on the PSFCH feedback resource.

The information transmission apparatus provided in the embodiment is configured to implement the information transmission method applied to the first communication node described in the embodiments shown in FIG. 3. The information transmission apparatus provided in the embodiments has similar implementation principles and technical effects, and the details are not repeated here.

In an embodiment, FIG. 13 is a block diagram of another information transmission apparatus according to an embodiment of the present application. The embodiment is applied to an information transmission device. The information transmission device is a second communication node. As shown in FIG. 13, the embodiment includes a second receiver 1310 and a second sender 1320.

The second receiver 1310 is configured to receive feedback indication information sent by a first communication node according to configuration information or pre-configuration information.

The second sender 1320 is configured to send feedback information to the first communication node according to the configuration information or pre-configuration information and the feedback indication information.

In an embodiment, the feedback indication information includes at least one of the following: first feedback indication information indicated in physical layer control information or second feedback indication information indicated in a higher-layer signaling.

In an embodiment, the operation of sending the feedback information to the first communication node according to the configuration information or pre-configuration information and the feedback indication information includes one of the following operations of:
sending the feedback information to the first communication node on a PSFCH feedback resource according to the configuration information or pre-configuration information and first feedback indication information;
sending the feedback information to the first communication node by using a sidelink data channel and/or a sidelink control channel in a feedback delay according to the configuration information or pre-configuration information, first feedback indication information and second feedback indication information;
sending the feedback information to the first communication node on a PSFCH feedback resource according to the configuration information or pre-configuration information, first feedback indication information and second feedback indication information; or
sending the feedback information to the first communication node by using a sidelink data channel and/or a sidelink control channel in a feedback delay according to the configuration information or pre-configuration information and first feedback indication information.

In an embodiment, the first feedback indication information is indication information in an SCI.

The first feedback indication information includes at least one of the following: 1-bit indication information, bitmap indication information, to-be-fed-back HARQ process group index indication information, SL-SAI indication information or NFI indication information.

In an embodiment, the second feedback indication information is indication information carried in a higher layer on a sidelink.

The second feedback indication information includes one of the following: to-be-fed-back HARQ process indication information, to-be-fed-back HARQ process group index indication information, to-be-fed-back slot indication information, or to-be-fed-back slot group index indication information.

In an embodiment, the configuration information or pre-configuration information includes one of the following: information for configuring K groups of HARQ processes, where K is a positive integer greater than or equal to 1; or a feedback delay.

In an embodiment, the first feedback indication information includes 1-bit indication information.

The 1-bit indication information is used for indicating that feedback information on the PSFCH feedback resource at least includes one of the following: feedback information of an HARQ process corresponding to current data, or feedback information of all to-be-fed-back HARQ processes in an HARQ process group in which an HARQ process corresponding to current data is located.

In an embodiment, the first feedback indication information includes to-be-fed-back HARQ process group index indication information. The to-be-fed-back HARQ process group index indication information is represented by a code point, and the number of code points is related to the number of HARQ process groups.

The to-be-fed-back HARQ process group index indication information is used for indicating that feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

One code point is used for indicating feeding back the feedback information of the HARQ process corresponding to the current data, and other code points are in a one-to-one correspondence with group indexes of the HARQ process groups.

In an embodiment, the grouping manner of the HARQ process groups includes one of the following operations of:
directly pre-configuring or configuring K groups of HARQ processes; or
pre-configuring or configuring the total number of HARQ processes and the number of processes in an HARQ process group, and determining K groups of HARQ processes according to the number of processes in the HARQ process group and the total number of HARQ processes.

In an embodiment, the first feedback indication information includes one of the following: 1-bit indication information, SL-SAI indication information or NFI indication information.

The 1-bit indication information is used for indicating that feedback information on the PSFCH feedback resource includes one of the following: feedback information of an HARQ process corresponding to current data, or feedback information of HARQ processes corresponding to current data and all to-be-fed-back data. The to-be-fed-back data is all data for which feedback is required and is before the current data and determined according to at least one of an SL-SAI or an NFI.

The SL-SAI indication information is used for indicating a count index of an SCI in a PSCCH.

The NFI indication information is used for indicating whether current SL-SAI indication information is a new count index.

In an embodiment, the configuration information or pre-configuration information includes a feedback delay, the first feedback indication information includes 1-bit indication information, and the second feedback indication information includes to-be-fed-back HARQ process indication information or to-be-fed-back HARQ process group index indication information.

The 1-bit indication information is used for indicating an enabling situation of sending feedback information in the feedback delay.

The to-be-fed-back HARQ process indication information is used for indicating process numbers of all processes, for which HARQ is to be fed back, before current data.

The to-be-fed-back HARQ process group index indication information is used for indicating HARQ processes in all process groups, for which HARQ is to be fed back, before current data.

The starting position of the feedback delay includes one of the following: a slot in which a PSFCH feedback resource corresponding to current data is located, a first slot after a slot in which a PSFCH feedback resource corresponding to current data is located, a slot in which a data resource or a control resource is located, or a first slot after a slot in which a data resource or a control resource is located.

In an embodiment, the configuration information or pre-configuration information includes a feedback delay, the first feedback indication information includes 1-bit indication information, and the second feedback indication information includes to-be-fed-back slot indication information or to-be-fed-back slot group index indication information.

The 1-bit indication information is used for indicating an enabling situation of sending feedback information in the feedback delay.

The to-be-fed-back slot indication information is used for indicating indexes of all slots, for which feedback is to be performed, before a slot corresponding to current data.

The to-be-fed-back slot group index indication information is used for indicating HARQ processes on to-be-fed-back slots in all slot groups, for which feedback is to be performed, before a slot corresponding to current data.

The starting position of the feedback delay includes one of the following: a slot in which a PSFCH feedback resource corresponding to current data is located, a first slot after a slot in which a PSFCH feedback resource corresponding to current data is located, a slot in which a data resource or a control resource is located, or a first slot after a slot in which a data resource or a control resource is located.

In an embodiment, the first feedback indication information includes 1-bit indication information, and the second feedback indication information includes to-be-fed-back HARQ process indication information or to-be-fed-back HARQ process group index indication information.

The 1-bit indication information is used for indicating that feedback information on the PSFCH feedback resource includes one of the following: feedback information of an HARQ process corresponding to current data, or feedback information of an HARQ process corresponding to current data and feedback information of a specified HARQ process.

Alternatively, the 1-bit indication information is used for indicating that feedback information on the PSFCH feedback resource includes one of the following: feedback information of an HARQ process corresponding to current data, or feedback information of an HARQ process corresponding to current data and feedback information of all to-be-fed-back HARQ processes, other than the HARQ process corresponding to the current data, in a specified HARQ process group.

The to-be-fed-back HARQ process indication information is used for indicating a process number of a specified HARQ process.

The to-be-fed-back HARQ process group index indication information is used for indicating an HARQ process in a specified HARQ process group.

In an embodiment, the first feedback indication information includes bitmap indication information. The bitmap indication information is used for indicating that feedback information on the PSFCH feedback resource includes that: bits in a bitmap is in a one-to-one correspondence with HARQ processes, and when a bit corresponding to an HARQ process in the bitmap is set to 1, it is represented that feedback information of the corresponding HARQ process is fed back on the PSFCH feedback resource.

In the above embodiments, in the feedback information the HARQ process corresponding to the current data and the to-be-fed-back HARQ processes belong to the same HARQ process group. The feedback information corresponding to HARQ processes is sorted in an order of process numbers from smallest to largest or from largest to smallest, and the feedback information is in a one-to-one correspondence with data of HARQ processes in an HARQ process group in which the HARQ processes corresponding to the feedback information is located.

In the above embodiments, in the feedback information the HARQ process corresponding to the current data and the to-be-fed-back HARQ processes do not belong to the same HARQ process group. The feedback information of the HARQ process corresponding to the current data is located before or after the feedback information of all to-be-fed-back HARQ processes; the feedback information of the to-be-fed-back HARQ processes is sorted in an order of process numbers from smallest to largest or from largest to smallest, and the feedback information is in a one-to-one correspondence with data of each HARQ process.

In the above embodiments, the feedback information is sorted in an order of process numbers from smallest to largest or from largest to smallest, and the feedback information is in a one-to-one correspondence with data of each to-be-fed-back HARQ process.

In the above embodiments, the feedback information is sorted in an order of SL-SAI values from smallest to largest or from largest to smallest, and the feedback information is in a one-to-one correspondence with each to-be-fed-back data.

In the above embodiments, the feedback information is sorted in an order of slot index values from smallest to largest or from largest to smallest, and the feedback information is in a one-to-one correspondence with data in each to-be-fed-back slot.

In the above embodiments, each feedback bit in the feedback information is in a one-to-one correspondence with each to-be-fed-back data.

The feedback bit generates ACK information or NACK information according to the receiving situation of to-be-fed-back data. For a to-be-fed-back HARQ process, a to-be-fed-back slot or to-be-fed-back data which is not received, the feedback bit generates NACK information.

The information transmission apparatus provided in the embodiments is configured to implement the information transmission method applied to the second communication node described in the embodiment shown in FIG. 4. The information transmission apparatus provided in the embodiments has similar implementation principles and technical effects, and the details are not repeated here.

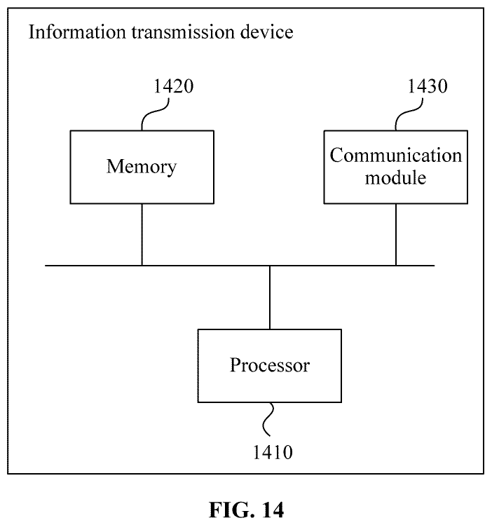

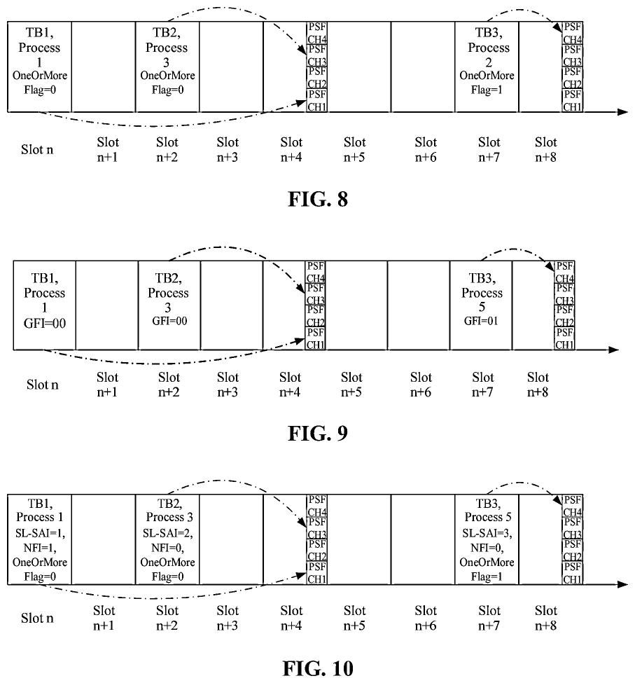

FIG. 14 is a structure diagram of an information transmission device according to an embodiment of the present application. As shown in FIG. 14, the device provided by the present application includes a processor 1410, a memory 1420 and a communication module 1430. The number of processors 1410 in the device may be one or more, and one processor 1410 is illustrated as an example in FIG. 14. The number of memories 1420 in the device may be one or more, and one memory 1420 is illustrated as an example in FIG. 14. The processor 1410, the memory 1420 and the communication module 1430 in the device may be connected via a bus or in other manners, and the connection via a bus is illustrated as an example in FIG. 14. In the embodiment, the device may be a transmitting end UE.

As a computer-readable storage medium, the memory 1420 may be configured to store software programs, and computer-executable programs and modules, such as program instructions/modules (for example, the first sender 1210 and the first receiver 1220 in the information transmission apparatus) corresponding to the device according to any of the embodiments of the present application. The memory 1420 may include a program storage region and a data storage region. The program storage region may store an operating system and an application program required by at least one function. The data storage region may store data created according to the use of the device. In addition, the memory 1420 may include a high-speed random-access memory and may further include a non-volatile memory, such as at least one disk memory, a flash memory or another non-volatile solid-state memory. In some examples, the memory 1420 may include memories which are remotely disposed relative to the processor 1410, and these remote memories may be connected to the device via a network. Examples of the preceding network include, but are not limited to, the Internet, an intranet, a local area network, a mobile communication network, and a combination thereof.

The communication module 1430 is configured to perform communication interaction among multiple communication nodes.

In the case where the information transmission device is the first communication node, the information transmission device may be configured to perform the information transmission method applied to the first communication node described in any of the preceding embodiments and has corresponding functions and effects.

In the case where the information transmission device is the second communication node, the information transmission device may be configured to perform the information transmission method applied to the second communication node described in any of the preceding embodiments and has corresponding functions and effects.

The embodiments of the present application further provide a storage medium including computer-executable instructions which, when executed by a computer processor, are used for performing an information transmission method applied to a first communication node. The method includes the following operations: feedback indication information is sent to a second communication node according to configuration information or pre-configuration information, and feedback information sent by the second communication node according to the configuration information or pre-configuration information and the feedback indication information is received.

The embodiments of the present application further provide a storage medium including computer-executable instructions which, when executed by a computer processor, are used for performing an information transmission method applied to a second communication node. The method includes the following operations: feedback indication information sent by a first communication node according to configuration information or pre-configuration information is received, and feedback information is sent to the first communication node according to the configuration information or pre-configuration information and the feedback indication information.

It is to be understood by those skilled in the art that the term “user equipment” encompasses any suitable type of wireless user device, for example, a mobile phone, a portable data processing apparatus, a portable web browser or a vehicle-mounted mobile station.

Generally speaking, the embodiments of the present application may be implemented in hardware or special-purpose circuits, software, logic or any combination thereof. For example, some aspects may be implemented in hardware while other aspects may be implemented in firmware or software executable by a controller, a microprocessor or another computing apparatus, though the present application is not limited thereto.

The embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination of program steps and logic circuits, modules, and functions. Computer programs may be stored in a memory. The memory may be of any type suitable for a local technical environment and may be implemented using any suitable data storage technology, such as, but not limited to, a read-only memory (ROM), a random-access memory (RAM), or an optical memory device and system (for example, a digital video disc (DVD) or a compact disc (CD)). Computer-readable media may include non-transitory storage media. The data processor may be of any type suitable for a local technical environment, for example, but not limited to, a general-purpose computer, a special-purpose computer, a microprocessor, digital signal processing (DSP), an application-specific integrated circuit (ASIC), a field-programmable gate array (FGPA) and a processor based on a multi-core processor architecture.

1. An information transmission method, applied to a first communication node and comprising:
sending feedback indication information to a second communication node according to configuration information or pre-configuration information; and
receiving feedback information sent by the second communication node according to the configuration information or pre-configuration information and the feedback indication information.

2. The method of claim 1, wherein the feedback indication information comprises one of the following:
first feedback indication information indicated in physical layer control information, wherein the first feedback indication information is indication information in sidelink control information (SCI), and the first feedback indication information comprises at least one of the following: 1-bit indication information, bitmap indication information, to-be-fed-back HARQ process group index indication information, sidelink counter assignment index (SL-SAI) indication information, or new feedback indication (NFI) indication information; or
second feedback indication information indicated in a higher-layer signaling, wherein the second feedback indication information is indication information carried in a higher layer on a sidelink, and the second feedback indication information comprises one of the following: to-be-fed-back hybrid automatic repeat request (HARQ) process indication information, to-be-fed-back HARQ process group index indication information, to-be-fed-back slot indication information, or to-be-fed-back slot group index indication information.

3. The method of claim 2, wherein receiving the feedback information sent by the second communication node according to the configuration information or pre-configuration information and the feedback indication information comprises one of the following:
receiving feedback information sent by the second communication node on a corresponding physical sidelink feedback channel (PSFCH) feedback resource according to the configuration information or pre-configuration information and the first feedback indication information;
receiving feedback information sent by the second communication node by using at least one of a sidelink data channel or a sidelink control channel in a feedback delay according to the configuration information or pre-configuration information, the first feedback indication information and the second feedback indication information;
receiving feedback information sent by the second communication node on a corresponding PSFCH feedback resource according to the configuration information or pre-configuration information, the first feedback indication information and the second feedback indication information; or
receiving feedback information sent by the second communication node by using at least one of a sidelink data channel or a sidelink control channel in a feedback delay according to the configuration information or pre-configuration information and the first feedback indication information.

4. (canceled)

5. (canceled)

6. The method of claim 1, wherein the configuration information or pre-configuration information comprises one of the following:
information for configuring K groups of HARQ processes, wherein K is a positive integer greater than or equal to 1; or
a feedback delay.

7. The method of claim 3, wherein the first feedback indication information comprises 1-bit indication information;
wherein the 1-bit indication information is used for indicating that the feedback information on the PSFCH feedback resource comprises one of the following: feedback information of an HARQ process corresponding to current data or feedback information of all to-be-fed-back HARQ processes in an HARQ process group in which an HARQ process corresponding to current data is located.

8. The method of claim 3, wherein the first feedback indication information comprises to-be-fed-back HARQ process group index indication information, the to-be-fed-back HARQ process group index indication information is represented by a code point and a number of code points is related to a number of HARQ process groups;
wherein the to-be-fed-back HARQ process group index indication information is used for indicating that the feedback information on the PSFCH feedback resource comprises one of the following: feedback information of an HARQ process corresponding to current data; or feedback information of an HARQ process corresponding to current data and feedback information of all to-be-fed-back HARQ processes, other than the HARQ process corresponding to the current data, in a specified HARQ process group;
wherein one code point is used for indicating feeding back the feedback information of the HARQ process corresponding to the current data, and code points, other than the one code point indicating feeding back the feedback information of the HARQ process corresponding to the current data, are in a one-to-one correspondence with group indexes of the HARQ process groups.

9. The method of claim 7, wherein a grouping manner of the HARQ process groups comprises one of the following:
directly pre-configuring or configuring K groups of HARQ processes; or
pre-configuring or configuring a total number of HARQ processes and a number of processes in an HARQ process group, and determining K groups of HARQ processes according to the number of processes in the HARQ process group and the total number of HARQ processes.

10. The method of claim 3, wherein the first feedback indication information comprises one of the following: 1-bit indication information, SL-SAI indication information, or NFI indication information;
wherein the 1-bit indication information is used for indicating that the feedback information on the PSFCH feedback resource comprises one of the following: feedback information of an HARQ process corresponding to current data; or feedback information of HARQ processes corresponding to current data and all to-be-fed-back data; wherein the to-be-fed-back data is data for which feedback is required and is before the current data and determined according to at least one of an SL-SAI or an NFI;
the SL-SAI indication information is used for indicating a count index of an SCI in a physical sidelink control channel (PSCCH);
the NFI indication information is used for indicating whether current SL-SAI indication information is a new count index.

11. The method of claim 3, wherein the configuration information or pre-configuration information comprises a feedback delay; the first feedback indication information comprises 1-bit indication information; and the second feedback indication information comprises to-be-fed-back HARQ process indication information or to-be-fed-back HARQ process group index indication information;
wherein the 1-bit indication information is used for indicating an enabling situation of sending feedback information in the feedback delay;
the to-be-fed-back HARQ process indication information is used for indicating process numbers of all processes, for which HARQ is to be fed back, before current data;
the to-be-fed-back HARQ process group index indication information is used for indicating HARQ processes in all process groups, for which HARQ is to be fed back, before current data;
a starting position of the feedback delay comprises one of the following: a slot in which a PSFCH feedback resource corresponding to current data is located; a first slot after a slot in which a PSFCH feedback resource corresponding to current data is located; a slot in which a data resource or a control resource is located; or a first slot after a slot in which a data resource or a control resource is located.

12. The method of claim 3, wherein the configuration information or pre-configuration information comprises a feedback delay; the first feedback indication information comprises 1-bit indication information; and the second feedback indication information comprises to-be-fed-back slot indication information or to-be-fed-back slot group index indication information;
wherein the 1-bit indication information is used for indicating an enabling situation of sending feedback information in the feedback delay;
the to-be-fed-back slot indication information is used for indicating indexes of all slots, for which feedback is to be performed, before a slot corresponding to current data;
the to-be-fed-back slot group index indication information is used for indicating HARQ processes on to-be-fed-back slots in all groups, for which feedback is to be performed, before a slot corresponding to current data;
a starting position of the feedback delay comprises one of the following: a slot in which a PSFCH feedback resource corresponding to current data is located; a first slot after a slot in which a PSFCH feedback resource corresponding to current data is located; a slot in which a data resource or a control resource is located; or a first slot after a slot in which a data resource or a control resource is located.

13. The method of claim 3, wherein the first feedback indication information comprises 1-bit indication information; the second feedback indication information comprises to-be-fed-back HARQ process indication information or to-be-fed-back HARQ process group index indication information;
wherein the 1-bit indication information is used for indicating that the feedback information on the PSFCH feedback resource comprises one of the following: feedback information of an HARQ process corresponding to current data; or feedback information of an HARQ process corresponding to current data and feedback information of a specified HARQ process; or
the 1-bit indication information is used for indicating that feedback information on the PSFCH feedback resource comprises one of the following: feedback information of an HARQ process corresponding to current data; or feedback information of an HARQ process corresponding to current data and feedback information of all to-be-fed-back HARQ processes, other than the HARQ process corresponding to the current data, in a specified HARQ process group;
the to-be-fed-back HARQ process indication information is used for indicating a process number of a specified HARQ process;
the to-be-fed-back HARQ process group index indication information is used for indicating an HARQ process in a specified HARQ process group.

14. The method of claim 3, wherein the first feedback indication information comprises bitmap indication information;
wherein the bitmap indication information is used for indicating that the feedback information on the PSFCH feedback resource comprises: bits in a bitmap being in a one-to-one correspondence with HARQ processes, wherein a bit corresponding to an HARQ process in the bitmap is set to 1 which represents that feedback information of the corresponding HARQ process is fed back on the PSFCH feedback resource.

15. An information transmission method, applied to a second communication node and comprising:
receiving feedback indication information sent by a first communication node according to configuration information or pre-configuration information; and
sending feedback information to the first communication node according to the configuration information or pre-configuration information and the feedback indication information.

16. The method of claim 15, wherein the sending the feedback information to the first communication node according to the configuration information or pre-configuration information and the feedback indication information, comprises one of the following:
sending, according to the configuration information or pre-configuration information and first feedback indication information, the feedback information to the first communication node on a physical sidelink feedback channel (PSFCH) feedback resource;
sending, according to the configuration information or pre-configuration information, first feedback indication information and second feedback indication information, the feedback information to the first communication node by using at least one of a sidelink data channel or a sidelink control channel in a feedback delay;
sending, according to the configuration information or pre-configuration information, first feedback indication information and second feedback indication information, the feedback information to the first communication node on a PSFCH feedback resource; or
sending, according to the configuration information or pre-configuration information and first feedback indication information, the feedback information to the first communication node by using at least one of a sidelink data channel or a sidelink control channel in a feedback delay.

17. The method of claim 15, wherein in the feedback information a hybrid automatic repeat request (HARQ) process corresponding to current data and a to-be-fed-back HARQ process belong to a same HARQ process group;
feedback information corresponding to HARQ processes is sorted in an order of process numbers from smallest to largest or from largest to smallest, wherein the feedback information corresponding to each of the HARQ processes is in a one-to-one correspondence with data of each of the HARQ processes.

18. The method of claim 15, wherein in the feedback information an HARQ process corresponding to current data and a to-be-fed-back HARQ process do not belong to a same HARQ process group;
feedback information of the HARQ process corresponding to the current data is located before or after feedback information of all to-be-fed-back HARQ processes; the feedback information of the to-be-fed-back HARQ processes is sorted in an order of process numbers from smallest to largest or from largest to smallest, wherein the feedback information of the to-be-fed-back HARQ processes is in a one-to-one correspondence with data of each HARQ process.

19. The method of claim 15, wherein the feedback information is sorted in an order of process numbers from smallest to largest or from largest to smallest, wherein the feedback information is in a one-to-one correspondence with data of each to-be-fed-back HARQ process or
wherein the feedback information is sorted in an order of sidelink counter assignment index (SL-SAI) values from smallest to largest or from largest to smallest, wherein the feedback information is in a one-to-one correspondence with each to-be-fed-back data: or
wherein the feedback information is sorted in an order of slot index values from smallest to largest or from largest to smallest, wherein the feedback information is in a one-to-one correspondence with data in each to-be-fed-back slot.

20. (canceled)

21. (canceled)

22. The method of claim 15, wherein each feedback bit in the feedback information is in a one-to-one correspondence with each to-be-fed-back data;
wherein the feedback bit generates acknowledgment (ACK) information or non-acknowledgment (NACK) information according to a receiving situation of to-be-fed-back data; for an unreceived to-be-fed-back HARQ process, an unreceived to-be-fed-back slot or unreceived to-be-fed-back data, the feedback bit generates NACK information.

23. An information transmission device, comprising a communication module, a memory and one or more processors;
wherein the communication module is configured to perform communication interaction between a plurality of communication nodes;
the memory is configured to store one or more programs;
the one or more programs, when executed by the one or more processors, cause the one or more processors to implement:
sending feedback indication information to a second communication node according to configuration information or pre-configuration information; and
receiving feedback information sent by the second communication node according to the configuration information or pre-configuration information and the feedback indication information.

24. A non-transitory storage medium storing a computer program which, when executed by a processor, causes the processor to implement the method of claim 1.
